(19) United States
(12) Patent Application Publication
(10) Pub. No.: US 2024/0409756 A1
(43) Pub. Date: Dec. 12, 2024

(54) BINDER FOR SECONDARY CELL ELECTRODE, USE THEREOF, AND METHOD FOR MANUFACTURING BINDER FOR SECONDARY CELL ELECTRODE

(71) Applicant: TOAGOSEI CO., LTD., Tokyo (JP)

(72) Inventors: Kenichi YOSHIMORI, Aichi (JP); Naohiko SAITO, Aichi (JP); Tomoko NAKANO, Aichi (JP)

(73) Assignee: TOAGOSEI CO., LTD., Tokyo (JP)

(21) Appl. No.: 18/700,829

(22) PCT Filed: Oct. 26, 2022
(86) PCT No.: PCT/JP2022/039879

§ 371 Date: Apr. 12, 2024

(30) Foreign Application Priority Data
Oct. 28, 2021 (JP) 2021-176985

(51) Int. Cl. C09D 5/24; C08F 220/06; C08F 220/58; C09D 7/61; C09D 133/02; C09D 133/26; H01M 4/62

(52) U.S. Cl. CPC C09D 5/24; C08F 220/06; C08F 220/58; C09D 7/61; C09D 133/02; C09D 133/26; H01M 4/622; C08F 2800/20; C08F 2810/20

(57) ABSTRACT

The present invention provides a binder for a secondary battery electrode, capable of improving toughness of a binder coating film after immersion in an electrolytic solution, electrolytic solution resistance of a secondary battery electrode mixture layer, and cycle characteristics of a secondary battery. The binder for the secondary battery electrode, the binder containing a carboxyl group-containing polymer or a salt thereof, in which the carboxyl group-containing polymer contains 15 mass % or more and 99.9 mass % or less of a structural unit derived from an ethylenically unsaturated carboxylic acid monomer and 0.1 mass % or more and 85 mass % or less of a structural unit derived from a keto group-containing ethylenically unsaturated monomer relative to all the structural units, and at least a part of the keto group is a functional group used to form a chemical bond with a compound having reactivity with the keto group.

### TECHNICAL FIELD

The present invention relates to a binder for a secondary battery electrode, use thereof, and a method for manufacturing the binder for the secondary battery electrode.

### BACKGROUND ART

As a secondary battery, various power storage devices such as a nickel-hydride secondary battery, a lithium ion secondary battery, and an electric double layer capacitor have been put into practical use. Electrodes used in these secondary batteries are prepared by applying a composition for forming an electrode mixture layer containing an active material, a binder and the like onto a current collector, drying the composition, and the like. For example, in the lithium ion secondary battery, as a binder used in a composition for a negative electrode mixture layer, an aqueous binder containing styrene-butadiene rubber (SBR) latex and carboxymethylcellulose (CMC) is used. On the other hand, as a binder used for the positive mixture layer, N-methyl-2-pyrrolidone (NMP) solution of polyvinylidene fluoride (PVDF) is widely used.

In recent years, as applications of various secondary batteries expand, demands for improvement in energy density, reliability, and durability tend to increase. For example, specifications using a silicon-based active material as an active material for a negative electrode have been increasing for the purpose of increasing electric capacity of a lithium ion secondary battery. However, it is known that the silicon-based active material has a large volume change during charging and discharging, and there is a problem that peeling, falling off, or the like of the electrode mixture layer occurs as the silicon-based active material is repeatedly used, and as a result, the capacity of the battery decreases, and cycle characteristics (durability) deteriorate.

In order to suppress such a problem, studies have been made to improve the durability by firmly binding active materials with a binder (binding property), reducing the size of the active material to alleviate stress associated with swelling and shrinkage, or devising an additive of an electrolytic solution.

Under such circumstances, it has been reported that an acrylic acid-based polymer is effective as a binder having good cycle characteristics and having an effect of improving the durability of the negative electrode mixture layer using the silicon-based active material.

Patent Literature 1 discloses a binder containing a crosslinked acrylic acid-based polymer obtained by crosslinking polyacrylic acid with a specific crosslinking agent, and discloses that even when an active material containing silicon is used, the binder exhibits good cycle characteristics without breaking the electrode structure. Although the binder disclosed in Patent Literature 1 can impart good cycle characteristics, there is a demand for a binder capable of obtaining higher cycle characteristics as performance of the secondary battery is improved.

As the binder for the secondary battery electrode, capable of improving the cycle characteristics of the secondary battery, for example, Patent Literature 2 discloses a binder for the secondary battery electrode, containing a binder containing a copolymer of an ethylenically unsaturated alkali metal carboxylate neutralized product and vinyl alcohol, and a crosslinking agent having two or more functional groups capable of reacting with a carboxyl group and/or a hydroxyl group in the binder.

In addition, Patent Literature 3 discloses a binder for a secondary battery electrode, containing: resin fine particles containing 0.5 to 5 mass % of an ethylenically unsaturated carboxylic acid monomer and/or an amide group-containing ethylenically unsaturated monomer and 0.1 to 10 mass % of a structural unit derived from a keto group-containing ethylenically unsaturated monomer; and a polyfunctional hydrazide compound having two or more hydrazide groups capable of reacting with the keto group.

### CITATION LIST

### Patent Literature

Patent Literature 1: WO 2014/065407 A
Patent Literature 2: WO 2019/054348 A
Patent Literature 3: JP-A-2011-134618

### SUMMARY OF INVENTION

### Problems to be Solved by Invention

In any of the binders for secondary battery electrodes disclosed in Patent Literatures 2 and 3, good cycle characteristics can be obtained by reaction between a functional group in the binder and a functional group in the crosslinking agent, but there are cases where the cycle characteristics are insufficient, and toughness of a binder coating film after immersion in an electrolytic solution is insufficient, and electrolytic solution resistance of a secondary battery electrode composite layer is insufficient, which sometimes caused problems.

The present invention has been made in view of such circumstances, and an object thereof is to provide a binder for a secondary battery electrode, capable of improving the toughness of a binder coating film after immersion in an electrolytic solution, the electrolytic solution resistance of the secondary battery electrode mixture layer, and the cycle characteristics of the secondary battery. In addition, another object of the present invention is to provide a composition for the secondary battery electrode mixture layer containing the binder, a secondary battery electrode and a secondary battery obtained using the composition.

As a result of intensive studies to solve the above problems, the present inventors have found that by using a binder for a secondary battery electrode, containing a carboxyl group-containing polymer or a salt thereof containing a specific amount of a structural unit derived from an ethylenically unsaturated carboxylic acid monomer and a keto group-containing ethylenically unsaturated monomer, in which at least a part of the keto group is a functional group used for forming a chemical bond with a compound having reactivity with the keto group, the toughness of the binder coating film after immersion in the electrolytic solution, the electrolytic solution resistance of the secondary battery electrode mixture layer, and the cycle characteristics of the secondary battery are further excellent, and have completed the present invention.

The present invention is as follows.

[1] A binder for a secondary battery electrode, the binder containing a carboxyl group-containing polymer or a salt thereof, in which the carboxyl group-containing polymer contains 15 mass % or more and 99.9 mass % or less of a structural unit derived from an ethylenically unsaturated carboxylic acid monomer and 0.1 mass % or more and 85 mass % or less of a structural unit derived from a keto group-containing ethylenically unsaturated monomer relative to all the structural units, and at least a part of the keto group is a functional group used to form a chemical bond with a compound having reactivity with the keto group.
[2] The binder for the secondary battery electrode according to [1], the binder further containing a compound (hereinafter, referred to as a “polyfunctional crosslinking agent”) having two or more functional groups having reactivity with the keto group.
[3] The binder for the secondary battery electrode according to [1] or [2], in which the carboxyl group-containing polymer is a crosslinked polymer.
[4] The binder for the secondary battery electrode according to [3], in which the crosslinked polymer is a crosslinked polymer obtained by polymerizing a monomer composition containing a non-crosslinkable monomer and a crosslinkable monomer (however, different from the polyfunctional crosslinking agent).
[5] The binder for the secondary battery electrode according to [4], in which an amount of the crosslinkable monomer used is 0.1 parts by mass or more and 2.0 parts by mass or less with respect to 100 parts by mass of a total amount of the non-crosslinkable monomer.
[6] The binder for the secondary battery electrode according to any one of [3] to [5], in which the crosslinked polymer has a particle diameter of 0.1 μm or more and 10.0 μm or less in terms of volume-based median diameter after being neutralized to a degree of neutralization of 80 to 100 mol % and then measured in an aqueous medium.
[7] The binder for the secondary battery electrode according to any one of [2] to [6], in which the polyfunctional crosslinking agent contains a polyfunctional crosslinking agent having a hydrazide group.
[8] A composition for a secondary battery electrode mixture layer, the composition containing the binder for the secondary battery electrode according to any one of [2] to [7], an active material, and water.
[9] The composition for the secondary battery electrode mixture layer according to [8], in which the active material contains a silicon-based active material.
[10] A secondary battery electrode including a mixture layer formed from the composition for the secondary battery electrode mixture layer according to [8] or [9] on a surface of a current collector.
[11] A secondary battery including the secondary battery electrode according to [10].
[12] A method for manufacturing a binder for a secondary battery electrode, the binder containing a carboxyl group-containing polymer or a salt thereof, in which the carboxyl group-containing polymer is obtained by a method including a step of polymerizing a monomer component containing an ethylenically unsaturated carboxylic acid monomer and a monomer component containing a keto group-containing ethylenically unsaturated monomer by precipitation polymerization or dispersion polymerization.
[13] The manufacturing method according to [12], in which the precipitation polymerization or the dispersion polymerization includes: a step of polymerizing the monomer component containing the ethylenically unsaturated carboxylic acid monomer; and a step of adding and polymerizing the monomer component containing the keto group-containing ethylenically unsaturated monomer in the middle of the above step.
[14] The manufacturing method according to [12] or [13], in which the carboxyl group-containing polymer contains 15 mass % or more and 99.9 mass % or less of the ethylenically unsaturated carboxylic acid monomer and 0.1 mass % or more and 85 mass % or less of the keto group-containing ethylenically unsaturated monomer.

### Effects of Invention

According to the binder for the secondary battery electrode of the present invention, it is possible to improve the toughness of the binder coating film after immersion in the electrolytic solution, the electrolytic solution resistance of the secondary battery electrode mixture layer, and the cycle characteristics of the secondary battery.

### DESCRIPTION OF EMBODIMENTS

A binder for a secondary battery electrode (hereinafter, also referred to as “present binder”) of the present invention contains a carboxyl group-containing polymer (hereinafter, also referred to as “present polymer”) or a salt thereof (hereinafter, also referred to as “present polymer salt”) containing a specific amount of an ethylenically unsaturated carboxylic acid monomer and a keto group-containing ethylenically unsaturated monomer, and can be mixed with a compound (hereinafter, referred to as a “polyfunctional crosslinking agent”) having two or more functional groups having reactivity with the keto group, an active material, and water to form a composition (hereinafter, also referred to as “present composition”) for a secondary battery electrode mixture layer. The above composition is preferably an electrode slurry in a slurry state capable of being applied to a current collector from the viewpoint of exerting an effect of the present invention, but may be prepared in a wet powder state so as to be able to cope with press working on a surface of a current collector. The secondary battery electrode of the present invention is obtained by forming a mixture layer formed of the above composition on the surface of the current collector such as a copper foil or an aluminum foil.

Here, when the present binder is used in the composition for the secondary battery electrode mixture layer containing a silicon-based active material described later as the active material, it is preferable from the viewpoint that the effect obtained by the present invention is particularly large.

Hereinafter, each of the polyfunctional crosslinking agent, the present polymer and a method for manufacturing the same, the composition for the secondary battery electrode mixture layer obtained using the present binder, the secondary battery electrode, and the secondary battery will be described in detail.

Note that in the present specification, “(meth)acryl” means acryl and/or methacryl, and “(meth)acrylate” means acrylate and/or methacrylate. Further, a “(meth)acryloyl group” means an acryloyl group and/or a methacryloyl group.

### 1. Polyfunctional Crosslinking Agent

The polyfunctional crosslinking agent is a compound having two or more functional groups having reactivity with the keto group contained in the present binder.

Examples of the functional group of the polyfunctional crosslinking agent include a hydrazide group, a semicarbazide group, and a hydrazone group.

Examples of the polyfunctional crosslinking agent having a hydrazide group include: aliphatic dicarboxylic acid dihydrazides such as maleic acid dihydrazide, oxalic acid dihydrazide, malonic acid dihydrazide, succinic acid dihydrazide, glutaric acid dihydrazide, adipic acid dihydrazide, and sebacic acid dihydrazide; alicyclic dicarboxylic acid dihydrazides such as trans-1,4-cyclohexanedicarbohydrazide; aromatic dicarboxylic acid dihydrazides such as isophthalic acid dihydrazide, terephthalic acid dihydrazide, and pyromellitic acid dihydrazide; and polycarboxylic acid hydrazides such as pyromellitic acid trihydrazide or tetrahydrazide, and polyacrylic acid polyhydrazide.

Examples of the polyfunctional crosslinking agent having a semicarbazide group include: aliphatic bis-semicarbazides such as 1,4-tetramethylene bis-N,N-dimethylsemicarbazide and 1,6-hexamethylene bis-N,N-dimethylsemicarbazide; alicyclic bis-semicarbazides such as a reaction product of polyisocyanate obtained from isophorone diisocyanate or isophorone diisocyanate with hydrazine, and aromatic bissemicarbazides such as 1,1,1′,1′-tetramethyl-4,4′-(methylene-di-para-phenylene) disemicarbazide.

Examples of the polyfunctional crosslinking agent having a hydrazone group include aliphatic dihydrazones such as bisacetyldihydrazone.

Among the polyfunctional crosslinking agents described above, it is preferable to use a relatively low molecular weight (about 300 or less) compound, and it is particularly preferable to use an aliphatic dihydrazide compound having 4 to 12 carbon atoms, such as succinic acid dihydrazide, glutaric acid dihydrazide, adipic acid dihydrazide, or sebacic acid dihydrazide, from the viewpoint that moderate hydrophilicity facilitates dispersion in an aqueous composition and a uniform crosslinked structure-phase secondary electrode composite layer can be obtained.

### 2. Present Polymer

The present polymer has a structural unit derived from an ethylenically unsaturated carboxylic acid monomer (hereinafter, also referred to as “component (a)”) and a structural unit derived from a keto group-containing ethylenically unsaturated monomer (hereinafter, also referred to as “component (b)”), and a monomer component containing the component (a) and the component (b) can be introduced into the polymer by precipitation polymerization or dispersion polymerization.

Further, the present polymer may be a crosslinked polymer (hereinafter, also referred to as “present crosslinked polymer”) or a non-crosslinked polymer. The present crosslinked polymer and the present non-crosslinked polymer may be used alone or in combination. Further, the present crosslinked polymer or the present non-crosslinked polymer may be used alone or in combination.

<Structural Unit Derived from Ethylenically Unsaturated Carboxylic Acid Monomer>

When the present polymer has a carboxyl group by having a structural unit derived from the component (a), adhesiveness to the current collector is improved, and a lithium ion desolvation effect and ion conductivity are excellent, so that an electrode having low resistance and excellent high-rate characteristics can be obtained. In addition, since water swellability is imparted, dispersion stability of the active material and the like in the present composition can be enhanced.

Examples of the component (a) include: (meth)acrylic acid, itaconic acid, crotonic acid, maleic acid, and fumaric acid; (meth)acrylamide alkyl carboxylic acid such as (meth)acrylamide hexanoic acid and (meth)acrylamide dodecanoic acid; carboxyl group-containing ethylenically unsaturated monomers such as monohydroxyethyl succinate (meth)acrylate, ω-carboxy-caprolactone mono (meth)acrylate, and β-carboxyethyl (meth)acrylate, or (partially) alkali-neutralized products thereof, and one of these may be used alone, or two or more thereof may be used in combination. Among the above, a compound having an acryloyl group as a polymerizable functional group is preferable, and acrylic acid is particularly preferable from the viewpoint that a polymer having a long primary chain length is obtained due to a high polymerization rate and binding force of the binder is improved. When acrylic acid is used as the ethylenically unsaturated carboxylic acid monomer, a polymer having a high carboxyl group content can be obtained.

The content of the component (a) in the present polymer ranges from 15 mass % to 99.9 mass % relative to all the structural units of the present polymer. By containing the component (a) within such a range, electrolytic solution resistance can be improved and the secondary battery electrode composite layer can be made tougher. When the lower limit is 20.0 mass % or more, it is preferable because it further improves the electrolytic solution resistance and the toughness of the secondary battery electrode composite layer, and the lower limit may be, for example, 30 mass % or more, for example, 40.0 mass % or more, or for example, 50.0 mass % or more. Further, the upper limit is, for example, 96.0 mass % or less, for example, 90.0 mass % or less, for example, 80.0 mass % or less, or for example, 70.0 mass % or less. The range of the content of the component (a) can be set to a range in which the lower limits and the upper limits are appropriately combined.

<Structural Unit Derived from Keto Group-Containing Ethylenically Unsaturated Monomer>

When the present polymer has a keto group by having a structural unit derived from the component (b), a crosslinked structure between the present polymers is formed by reaction with the polyfunctional crosslinking agent, toughness of a binder coating film after immersion in the electrolytic solution is improved, and the secondary battery electrode composite layer can be made tougher. Accordingly, it is presumed that the electrolytic solution resistance of the secondary battery electrode mixture layer and cycle characteristics of the secondary battery can be improved.

Examples of the component (b) include: keto group-containing (meth)acrylamides such as diacetone (meth)acrylamide; keto group-containing vinyl compounds such as N-vinylformamide, vinyl methyl ketone, and vinyl ethyl ketone; keto group-containing (meth)acrylates such as acetoacetoxyethyl (meth)acrylate, acetoacetoxypropyl (meth)acrylate, and acetoacetoxybutyl (meth)acrylate; and unsaturated aldehydes such as acrolein, and one of these may be used alone, or two or more thereof may be used in combination. Among the above, from the viewpoint of excellent electrolytic solution resistance, keto group-containing (meth)acrylamide and keto group-containing (meth)acrylate are preferable, and diacetone (meth)acrylamide, acetoacetoxyethyl (meth)acrylate, acetoacetoxypropyl (meth)acrylate, and acetoacetoxybutyl (meth)acrylate are more preferable.

Further, keto group-containing (meth)acrylamide is further more preferable, and diacetone (meth)acrylamide is particularly preferable because it is further excellent in electrolytic solution resistance.

The content of the component (b) in the present polymer ranges from 0.1 mass % to 85 mass % relative to all the structural units of the present polymer. By containing the component (b) within such a range, the secondary battery electrode composite layer can be made tougher. When the lower limit is 0.5 mass % or more, it is preferable because it further makes the secondary battery electrode composite layer tougher, and the lower limit may be, for example, 2 mass % or more, for example, 4 mass % or more, or for example, 10 mass % or more. Further, the upper limit is, for example, 70 mass % or less, for example, 60 mass % or less, for example, 50 mass % or less, or for example, 40 mass % or less, and in particular, the upper limit is preferably 35 mass % or less from the viewpoint that the electrolytic solution swelling degree of the binder coating film can be reduced and sufficient electrolytic solution resistance can be obtained. The range of the content of the component (b) can be set to a range in which the lower limits and the upper limits are appropriately combined.

### <Other Structural Units>

The present polymer may contain, in addition to the components (a) and (b), a structural unit (hereinafter, also referred to as “component (c)”) derived from another ethylenically unsaturated monomer copolymerizable therewith. Examples of the component (c) include a structural unit derived from a hydroxyl group-containing ethylenically unsaturated monomer (monomer represented by the following formula (1) and monomer represented by the following formula (2)), an ethylenically unsaturated monomer compound having an anionic group other than a carboxyl group such as a sulfonic acid group and a phosphoric acid group, or a nonionic ethylenically unsaturated monomer. These structural units can be introduced by copolymerizing an ethylenically unsaturated monomer compound having an anionic group other than a carboxyl group such as a sulfonic acid group and a phosphoric acid group, or a monomer containing a nonionic ethylenically unsaturated monomer.

CH₂═C(R¹)COOR² (1)

[in which R¹ represents a hydrogen atom or a methyl group, and R² represents a monovalent organic group having a hydroxyl group and 1 to 8 carbon atoms, (R³O)ₘH or R⁴O[CO(CH₂)₅O]ₙH. R³ represents an alkylene group having 2 to 4 carbon atoms, R⁴ represents an alkylene group having 1 to 8 carbon atoms, m represents an integer of 2 to 15, and n represents an integer of 1 to 15.]

CH₂═C(R⁵)CONR⁶R⁷ (2)

[in which R⁵ represents a hydrogen atom or a methyl group, and R⁶ represents a hydroxyl group or a hydroxyalkyl group having 1 to 8 carbon atoms, and R⁷ represents a hydrogen atom or a monovalent organic group.]

A ratio of the component (c) can be 0.1 mass % or more and 20 mass % or less relative to all the structural units of the present polymer. The ratio of the component (c) may be 0.5 mass % or more and 17.5 mass % or less, 1.0 mass % or more and 15 mass % or less, 2 mass % or more and 12.5 mass % or less, or 3 mass % or more and 10 mass % or less. In addition, when the component (c) is contained in an amount of 0.1 mass % or more relative to all the structural units of the present polymer, since affinity to the electrolytic solution is improved, an effect of improving lithium ion conductivity can also be expected.

As the component (c), among the components described above, the hydroxyl group-containing ethylenically unsaturated monomer is preferable from the viewpoint of excellent binding property of the binder containing the present polymer salt. In addition, a structural unit derived from a nonionic ethylenically unsaturated monomer is preferable from the viewpoint of obtaining an electrode having good bending resistance, and examples of the nonionic ethylenically unsaturated monomer include (meth)acrylamide and derivatives thereof, a nitrile group-containing ethylenically unsaturated monomer, and an alicyclic structure-containing ethylenically unsaturated monomer.

The monomer represented by the formula (1) is a (meth)acrylate compound having a hydroxyl group. When R² is a monovalent organic group having a hydroxyl group and 1 to 8 carbon atoms, the number of hydroxyl groups may be only 1 or 2 or more. The monovalent organic group is not particularly limited, and examples thereof include an alkyl group that may have a linear, branched or cyclic structure, and an aryl group and an alkoxyalkyl group. Further, when R² is (R³O)ₘH or R⁴O[CO(CH₂)₅O]ₙH, the alkylene group represented by R³ or R⁴ may be linear or branched.

Examples of the monomer represented by the formula (1) include: hydroxyalkyl (meth)acrylates having a hydroxyalkyl group having 1 to 8 carbon atoms, such as 2-hydroxyethyl (meth)acrylate, 3-hydroxypropyl (meth)acrylate, 4-hydroxybutyl (meth)acrylate, hydroxyhexyl (meth)acrylate, and hydroxyoctyl (meth)acrylate; polyalkylene glycol mono(meth)acrylates such as polyethylene glycol mono(meth)acrylate, polypropylene glycol mono(meth)acrylate, polybutylene glycol mono(meth)acrylate, and polyethylene glycol-polypropylene glycol mono(meth)acrylate; dihydroxyalkyl (meth)acrylate such as glycerin mono(meth)acrylate; caprolactone-modified hydroxymethacrylate (trade names “PLACCEL FM1”, “PLACCEL FM5”, and the like manufactured by Daicel Corporation), and caprolactone-modified hydroxyacrylate (trade names “PLACCEL FA1”, “PLACCEL FA10L”, and the like manufactured by Daicel Corporation). One of the monomers represented by the formula (1) may be used alone, or two or more thereof may be used in combination.

The monomer represented by the formula (2) is a (meth)acrylamide derivative having a hydroxyl group or a hydroxyalkyl group having 1 to 8 carbon atoms. In the formula (2), R⁷ represents a hydrogen atom or a monovalent organic group. The monovalent organic group is not particularly limited, and examples thereof include an alkyl group that may have a linear, branched or cyclic structure, and an aryl group and an alkoxyalkyl group, and an organic group having 1 to 8 carbon atoms is preferable. In addition, R⁷ may be a hydroxyl group or a hydroxyalkyl group having 1 to 8 carbon atoms.

Examples of the monomer represented by the formula (2) include hydroxy (meth)acrylamide; (meth)acrylamide derivatives having a hydroxyalkyl group having 1 to 8 carbon atoms, such as N-hydroxyethyl (meth)acrylamide, N-hydroxypropyl (meth)acrylamide, N-hydroxybutyl (meth)acrylamide, N-hydroxyhexyl (meth)acrylamide, N-hydroxyoctyl (meth)acrylamide, N-methylhydroxyethyl (meth)acrylamide, and N-ethylhydroxyethyl (meth)acrylamide; N,N-di-hydroxyalkyl (meth)acrylamide such as N,N-dihydroxyethyl (meth)acrylamide and N,N-dihydroxyethyl (meth)acrylamide. One of the monomers represented by the formula (2) may be used alone, or two or more thereof may be used in combination.

Examples of the (meth)acrylamide derivative include: N-alkyl (meth)acrylamide compounds such as N-isopropyl (meth)acrylamide and N-t-butyl (meth)acrylamide; N-alkoxyalkyl (meth)acrylamide compounds such as N-n-butoxymethyl (meth)acrylamide and N-isobutoxymethyl (meth)acrylamide; and N,N-dialkyl (meth)acrylamide compounds such as N,N-dimethyl (meth)acrylamide and N,N-diethyl (meth)acrylamide, and one of these may be used alone, or two or more thereof may be used in combination.

Examples of the nitrile group-containing ethylenically unsaturated monomer include: (meth)acrylonitrile; cyanoalkyl (meth)acrylate ester compounds such as cyanomethyl (meth)acrylate and cyanoethyl (meth)acrylate; cyano group-containing unsaturated aromatic compounds such as 4-cyanostyrene and 4-cyano-α-methylstyrene; and vinylidene cyanide, and one of these may be used alone, or two or more thereof may be used in combination. Among the above, acrylonitrile is preferable from the viewpoint of having a large nitrile group content.

Examples of the alicyclic structure-containing ethylenically unsaturated monomer include: (meth)acrylic acid cycloalkyl esters that may have an aliphatic substituent such as cyclopentyl (meth)acrylate, cyclohexyl (meth)acrylate, methylcyclohexyl (meth)acrylate, t-butylcyclohexyl (meth)acrylate, cyclodecyl (meth)acrylate, and cyclododecyl (meth)acrylate; isobornyl (meth)acrylate; adamantyl (meth)acrylate; cyclopentenyl (meth)acrylate; dicyclopentenyloxyethyl (meth)acrylate; dicyclopentanyl (meth)acrylate; and cycloalkyl polyalcohol mono(meth)acrylates such as cyclohexanedimethanol mono(meth)acrylate and cyclodecanedimethanol mono(meth)acrylate, and one of these may be used alone, or two or more thereof may be used in combination.

The present polymer preferably contains a structural unit derived from the monomer represented by the formula (1), the monomer represented by the formula (2), (meth)acrylamide and derivatives thereof, the nitrile group-containing ethylenically unsaturated monomer, the alicyclic structure-containing ethylenically unsaturated monomer, and the like from the viewpoint of excellent binding property of the binder.

As the component (c), hydroxyalkyl (meth)acrylate having a hydroxyalkyl group having 1 to 8 carbon atoms is more preferable, and 2-hydroxyethyl (meth)acrylate, 3-hydroxypropyl (meth)acrylate, and 4-hydroxybutyl (meth)acrylate are still more preferable from the viewpoint of excellent effect of improving the binding property of the present binder.

In addition, as the component (c), when a structural unit derived from a hydrophobic ethylenically unsaturated monomer having a solubility in water of 1 g/100 ml or less is introduced, a strong interaction with an electrode material can be obtained, and good binding property to the active material can be exhibited. Thus, since a rigid electrode mixture layer with good integrity can be obtained, as the “hydrophobic ethylenically unsaturated monomer having a solubility in water of 1 g/100 ml or less” described above, the alicyclic structure-containing ethylenically unsaturated monomer is particularly preferable.

Further, as the other nonionic ethylenically unsaturated monomer, for example, a (meth)acrylic acid ester may be used. Examples of the (meth)acrylic acid ester include: (meth)acrylic acid alkyl ester compounds such as methyl (meth)acrylate, ethyl (meth)acrylate, n-butyl (meth)acrylate, isobutyl (meth)acrylate, and 2-ethylhexyl (meth)acrylate;
aromatic (meth)acrylic acid ester compounds such as phenyl (meth)acrylate, phenylmethyl (meth)acrylate, phenylethyl (meth)acrylate, and phenoxyethyl (meth)acrylate; and
(meth)acrylic acid alkoxyalkyl ester compounds such as 2-methoxyethyl (meth)acrylate and 2-ethoxyethyl (meth)acrylate, and one of these may be used alone, or two or more thereof may be used in combination.

From the viewpoint of the binding property to the active material and the cycle characteristics, an aromatic (meth)acrylic acid ester compound can be preferably used. From the viewpoint of further improving the lithium ion conductivity and the high-rate characteristics, compounds having an ether bond, such as (meth)acrylic acid alkoxyalkyl ester such as 2-methoxyethyl (meth)acrylate and 2-ethoxyethyl (meth)acrylate are preferable, and 2-methoxyethyl (meth)acrylate is more preferable.

Among the nonionic ethylenically unsaturated monomers, a compound having an acryloyl group is preferable from the viewpoint that due to a high polymerization rate, a polymer having a long primary chain length is obtained and the binding force of the binder is improved. In addition, as the nonionic ethylenically unsaturated monomer, a compound having a glass transition temperature (Tg) of a homopolymer of 0° C. or lower is preferable from the viewpoint that the bending resistance of the resulting electrode is improved.

Salt of the present polymer is in the form of a salt in which some or all of carboxyl groups contained in the polymer are neutralized. The type of salt is not particularly limited, and examples of the salt include: alkali metal salts such as a lithium salt, a sodium salt, and a potassium salt; alkaline earth metal salts such as a magnesium salt, a calcium salt, and a barium salt; other metal salts such as an aluminum salt; ammonium salts; and organic amine salts. Among them, the alkali metal salts and the alkaline earth metal salts are preferable, and the alkali metal salts are more preferable from the viewpoint that adverse effects on battery characteristics are less likely to occur.

### Present Crosslinked Polymer

The present polymer is preferably a polymer (a present crosslinked polymer) having a crosslinked structure from the viewpoint of achieving both the electrolytic solution resistance and the cycle characteristics. A crosslinking method in the present crosslinked polymer is not particularly limited, and for example, embodiments by the following methods are exemplified.
1) Copolymerization of crosslinkable monomers (however, different from the polyfunctional crosslinking agent)
2) Utilizing chain transfer to polymer chain during radical polymerization

Since the present crosslinked polymer has a crosslinked structure, the binder containing the present crosslinked polymer salt can have an excellent binding force. Among the above methods, a method by copolymerization of crosslinkable monomers is preferable from the viewpoint that an operation is simple and the degree of crosslinking can be easily controlled.

### <Crosslinkable Monomer>

Examples of the crosslinkable monomer include a polyfunctional polymerizable monomer having two or more polymerizable unsaturated groups, and a monomer having a crosslinkable functional group capable of self-crosslinking such as a hydrolyzable silyl group. However, they are different from the polyfunctional crosslinking agent.

The polyfunctional polymerizable monomer is a compound having two or more polymerizable functional groups such as a (meth)acryloyl group and an alkenyl group in the molecule, and examples thereof include a polyfunctional (meth)acryloyl compound, a polyfunctional alkenyl compound, and a compound having both a (meth)acryloyl group and an alkenyl group. One of these compounds may be used alone, or two or more thereof may be used in combination. Among them, from the viewpoint of easily obtaining a uniform crosslinked structure, the polyfunctional alkenyl compound is preferable and a polyfunctional allyl ether compound having two or more allyl ether groups in the molecule is particularly preferable.

Examples of the polyfunctional (meth)acryloyl compound include: di(meth)acrylates of dihydric alcohols such as ethylene glycol di(meth)acrylate, propylene glycol di(meth)acrylate, 1,6-hexanediol di(meth)acrylate, polyethylene glycol di(meth)acrylate, and polypropylene glycol di(meth)acrylate; poly(meth)acrylate such as tri(meth)acrylates or tetra (meth)acrylate of trivalent or higher polyhydric alcohol such as trimethylolpropane tri(meth)acrylate, tri(meth)acrylate of trimethylolpropane ethylene oxide modified product, glycerin tri(meth)acrylate, pentaerythritol tri(meth)acrylate, and pentaerythritol tetra(meth)acrylate; and bisamides such as methylene bisacrylamide and hydroxyethylene bisacrylamide.

Examples of the polyfunctional alkenyl compound include: polyfunctional allyl ether compounds such as trimethylolpropane diallyl ether, trimethylolpropane triallyl ether, pentaerythritol diallyl ether, pentaerythritol triallyl ether, tetraallyloxyethane, and polyallylsaccharose; polyfunctional allyl compounds such as diallyl phthalate; and polyfunctional vinyl compounds such as divinylbenzene.

Examples of the compound having both a (meth)acryloyl group and an alkenyl group include allyl (meth)acrylate, isopropenyl (meth)acrylate, butenyl (meth)acrylate, pentenyl (meth)acrylate, and 2-(2-vinyloxyethoxy)ethyl (meth)acrylate.

Specific examples of the monomer having a crosslinkable functional group capable of self-crosslinking include a hydrolyzable silyl group-containing vinyl monomer and N-methoxyalkyl (meth)acrylamide. One of these compounds can be used alone, or two or more thereof may be used in combination.

The hydrolyzable silyl group-containing vinyl monomer is not particularly limited as long as it is a vinyl monomer having at least one hydrolyzable silyl group. Examples of the hydrolyzable silyl group-containing vinyl monomer include: vinylsilanes such as vinyltrimethoxysilane, vinyltriethoxysilane, vinylmethyldimethoxysilane, and vinyldimethylmethoxysilane; silyl group-containing acrylic acid esters such as trimethoxysilylpropyl acrylate, triethoxysilylpropyl acrylate, and methyldimethoxysilylpropyl acrylate; silyl group-containing methacrylic acid esters such as trimethoxysilylpropyl methacrylate, triethoxysilylpropyl methacrylate, methyldimethoxysilylpropyl methacrylate, and dimethylmethoxysilylpropyl methacrylate; silyl group-containing vinyl ethers such as trimethoxysilylpropyl vinyl ether; and silyl group-containing vinyl esters such as vinyl trimethoxysilylundecanoate.

When the present crosslinked polymer is crosslinked with the crosslinkable monomer, an amount of the crosslinkable monomer used is preferably 0.01 parts by mass or more and 5.0 parts by mass or less, more preferably 0.05 parts by mass or more and 3.0 parts by mass or less, still more preferably 0.1 parts by mass or more and 2.0 parts by mass or less, still more preferably 0.1 parts by mass or more and 1.7 parts by mass or less, and yet still more preferably 0.5 parts by mass or more and 1.5 parts by mass or less relative to 100 parts by mass of a total amount of monomers (non-crosslinkable monomers) other than the crosslinkable monomer. The range of the amount of the crosslinkable monomer used can be a range in which the lower limits and the upper limits are appropriately combined. When the amount of the crosslinkable monomer used is 0.01 parts by mass or more, it is preferable from the viewpoint of further improving the binding property and sedimentation stability of the electrode slurry. When the amount of the crosslinkable monomer used is 5.0 parts by mass or less, stability of the precipitation polymerization or the dispersion polymerization tends to be improved.

For the same reason, the amount of the crosslinkable monomer used is preferably 0.001 to 2.5 mol %, more preferably 0.01 to 2.0 mol %, still more preferably 0.05 to 1.75 mol %, still more preferably 0.05 to 1.5 mol %, and yet still more preferably 0.1 to 1.0 mol % relative to the total amount of monomers (non-crosslinkable monomers) other than the crosslinkable monomer. The range of the amount of the crosslinkable monomer used can be a range in which the lower limits and the upper limits are appropriately combined.

### Properties of Present Crosslinked Polymer Salt

It is preferable that an acid group such as a carboxyl group derived from the ethylenically unsaturated carboxylic acid monomer is neutralized so that the degree of neutralization is 20 mol % or more in the present composition, and the present crosslinked polymer is used as a salt form. The degree of neutralization is more preferably 50 mol % or more, still more preferably 70 mol % or more, still more preferably 75 mol % or more, yet still more preferably 80 mol % or more, and particularly preferably 85 mol % or more. An upper limit value of the degree of neutralization is 100 mol %, and may be 98 mol % or 95 mol %. The range of the degree of neutralization can be obtained by appropriately combining the lower limit values and the upper limit values, and may be, for example, 50 mol % or more and 100 mol % or less, 75 mol % or more and 100 mol % or less, or 80 mol % or more and 100 mol % or less. When the degree of neutralization is 20 mol % or more, it is preferable from the viewpoint that the water swellability is improved, and a dispersion stabilizing effect is easily obtained. In the present specification, the degree of neutralization can be calculated from charged amount values of a monomer having an acid group such as a carboxyl group and a neutralizing agent used for neutralization. Note that the degree of neutralization can be confirmed from an intensity ratio of a peak derived from C═O group of a carboxylic acid to a peak derived from C═O group of a carboxylate by performing IR measurement of powders after the crosslinked polymer salt is dried at 80° C. for 3 hours under reduced pressure conditions.

### <Particle Diameter of Present Crosslinked Polymer Salt>

In the present composition, it is preferable that the present crosslinked polymer salt is not present as a mass (secondary aggregate) having a large particle diameter but is well dispersed as water-swelling particles having an appropriate particle diameter because the binder containing the crosslinked polymer salt can exhibit good binding performance.

The present crosslinked polymer preferably has a particle diameter (water-swelling particle diameter) in a range of 0.1 μm or more and 10.0 μm or less in terms of a volume-based median diameter when the crosslinked polymer having a degree of neutralization based on carboxyl groups possessed by the crosslinked polymer of 80 to 100 mol % is dispersed in water. The range of the particle diameter is more preferably 0.15 μm or more and 8.0 μm or less, still more preferably 0.20 μm or more and 6.0 μm or less, still more preferably 0.25 μm or more and 4.0 μm or less, and yet still more preferably 0.30 μm or more and 2.0 μm or less. When the particle diameter is in the range of 0.30 μm or more and 2.0 μm or less, the particles are uniformly present in the present composition in a suitable size, so that stability of the present composition is high and excellent binding property can be exhibited. When the particle diameter exceeds 10.0 μm, there is a possibility that the binding property is insufficient as described above. In addition, there is a possibility that coatability is insufficient from the viewpoint that a smooth coating surface is difficult to be obtained. On the other hand, when the particle diameter is less than 0.1 μm, there is a concern from the viewpoint of stable manufacturability.

### <Viscosity of Aqueous Solution of Present Crosslinked Polymer Salt>

The present crosslinked polymer salt preferably has a viscosity of 100 mPa·s or more in its 2 mass % aqueous solution. When the viscosity of the 2 mass % aqueous solution is 100 mPa·s or more, storage stability of the composition containing the crosslinked polymer is high, and excellent binding property can be exhibited. The viscosity of the 2 mass % aqueous solution may be 1,000 mPa·s or more, 10,000 mPa·s or more, or 50,000 mPa·s or more.

The viscosity of the aqueous solution is obtained by uniformly dissolving or dispersing the present crosslinked polymer salt in water in an amount to a predetermined concentration, and then measuring B-type viscosity (25° C.) at 12 rpm according to a method described in Examples.

The present crosslinked polymer salt is swollen by absorbing water in water. In general, when the crosslinked polymer has an appropriate degree of crosslinking, as an amount of hydrophilic groups possessed by the crosslinked polymer increases, the crosslinked polymer absorbs water and swells more easily. In addition, regarding the degree of crosslinking, as the degree of crosslinking is lower, the crosslinked polymer swells more easily. However, even when the number of crosslinking points is the same, as the molecular weight (primary chain length) is larger, the number of crosslinking points contributing to formation of a three-dimensional network increases, and thus the crosslinked polymer is less likely to swell. Therefore, the viscosity of the crosslinked polymer aqueous solution can be adjusted by adjusting the amount of hydrophilic groups, the number of crosslinking points, the primary chain length, and the like of the crosslinked polymer. At this time, the number of crosslinking points can be adjusted by, for example, the amount of the crosslinkable monomer used, a chain transfer reaction to the polymer chain, a post-crosslinking reaction, or the like. In addition, the primary chain length of the polymer can be adjusted by, for example, setting conditions related to a radical generation amount, such as an initiator and a polymerization temperature, or selecting a polymerization solvent in consideration of chain transfer and the like.

### <Water Swelling Degree of Present Crosslinked Polymer Salt>

In the present specification, water swelling degree is calculated based on the following formula from a dry weight “(W_{A}) g” of the crosslinked polymer salt and an amount “(W_{B}) g” of water absorbed when the crosslinked polymer salt is saturated and swollen with water.

$$( Water swelling degree ) = \{ ( {W}_{A} ) + ( {W}_{B} ) \} / ( {W}_{A} )$$

The crosslinked polymer salt preferably has a water swelling degree of 20 or more and 80 or less at pH 8. When the water swelling degree is within the above range, since the crosslinked polymer salt moderately swells in an aqueous medium, it is possible to secure a sufficient adhesion area to the active material and the current collector when forming the electrode mixture layer, and the binding property tends to be good. The water swelling degree may be, for example, 21 or more, 23 or more, 25 or more, 27 or more, or 30 or more. When the water swelling degree is 20 or more, the crosslinked polymer salt spreads on the surface of the active material or the current collector, and a sufficient adhesion area can be secured, so that good binding property can be obtained. An upper limit value of the water swelling degree at pH 8 may be 75 or less, 70 or less, 65 or less, 60 or less, or 55 or less. When the water swelling degree exceeds 60, a viscosity of the composition for the electrode mixture layer (electrode slurry) containing the crosslinked polymer salt tends to increase, and as a result of insufficient uniformity of the mixture layer, sufficient binding force may not be obtained. In addition, there is a possibility that coatability of the electrode slurry is deteriorated. The range of the water swelling degree at pH 8 can be set by appropriately combining the upper limit values and the lower limit values.

The water swelling degree at pH 8 can be obtained by measuring swelling degree of the crosslinked polymer salt in water at pH 8. As the water having a pH of 8, for example, ion-exchanged water can be used, and a pH value may be adjusted using an appropriate acid, alkali, a buffer solution, or the like as necessary. The pH at the time of measurement is, for example, in the range of 8.0±0.5, preferably in the range of 8.0±0.3, more preferably in the range of 8.0±0.2, and still more preferably in the range of 8.0±0.1. In addition, the measurement is performed at 25±5° C.

Note that those skilled in the art can adjust the water swelling degree by controlling the composition, structure, and the like of the crosslinked polymer salt. For example, the water swelling degree can be increased by introducing an acidic functional group or a highly hydrophilic structural unit into the crosslinked polymer. Further, by lowering the degree of crosslinking of the crosslinked polymer, the water swelling degree usually increases.

### 3. Method for Manufacturing Present Polymer

The present polymer is obtained by a method including a step of polymerizing a monomer component containing an ethylenically unsaturated carboxylic acid monomer and a monomer component containing a keto group-containing ethylenically unsaturated monomer by precipitation polymerization or dispersion polymerization.

Here, the precipitation polymerization is a method for manufacturing a polymer by performing a polymerization reaction in a solvent that dissolves a monomer that is a raw material but does not substantially dissolve a polymer to be produced. As the polymerization proceeds, polymer particles become larger due to aggregation and growth, and a dispersion of the polymer particles in which primary particles of several tens nm to several hundreds nm are secondarily aggregated into several μm to several tens μm is obtained. A dispersion stabilizer can also be used to control a particle size of the polymer.

Note that the secondary aggregation can also be suppressed by selecting the dispersion stabilizer, a polymerization solvent, or the like. In general, the precipitation polymerization in which the secondary aggregation is suppressed is also called the dispersion polymerization.

In addition, the precipitation polymerization or the dispersion polymerization preferably includes: a step of polymerizing the monomer component containing the ethylenically unsaturated carboxylic acid monomer; and a step of adding and polymerizing the monomer component containing the keto group-containing ethylenically unsaturated monomer in the middle of the above step. By doing so, particularly when producing the crosslinked polymer, a polar surface of the particle can be surface-modified with the keto group-containing ethylenically unsaturated monomer. Along with this, it is presumed that a reaction between the keto group and the polyfunctional crosslinking agent is promoted, and the toughness of the binder coating film after immersion in the electrolytic solution, the electrolytic solution resistance of the secondary battery electrode mixture layer, and the cycle characteristics of the secondary battery can be improved.

Here, in the present invention, the term “in the middle” means a time point of “0.3T to 0.8T” where T is a time from start of the step of polymerizing the present monomer to end of the step, and the time point is preferably 0.4T to 0.8T, more preferably 0.5T to 0.8T, and still more preferably 0.5T to 0.7T from the viewpoint that the binder containing the present polymer salt can exhibit the toughness of the binder coating film after immersion in the electrolytic solution, the electrolytic solution resistance of the secondary battery electrode mixture layer, and the cycle characteristics of the secondary battery. The range of the time point can be set by appropriately combining the lower limits and the upper limits.

Furthermore, the carboxyl group-containing polymer can contain 15 mass % or more and 99.9 mass % or less of the ethylenically unsaturated carboxylic acid monomer and 0.1 mass % or more and 85 mass % or less of the keto group-containing ethylenically unsaturated monomer. The types and amounts of the ethylenically unsaturated carboxylic acid monomer and the keto group-containing ethylenically unsaturated monomer used are as described above.

The crosslinking method in the present crosslinked polymer is not particularly limited, and for example, embodiments by the following methods are exemplified. From the viewpoint of easily controlling the degree of crosslinking, the method by copolymerization of the crosslinkable monomers is preferable, and the type and amount of the crosslinkable monomer used are as described above.

### 4. Composite for Secondary Battery Electrode Mixture Layer

The composition for the secondary battery electrode mixture layer of the present invention contains the present binder, the polyfunctional crosslinking agent, the active material, and water.

An amount of the present binder used in the present composition is, for example, 0.1 parts by mass or more and 20 parts by mass or less relative to 100 parts by mass of a total amount of the active material. The use amount is, for example, 0.2 parts by mass or more and 10 parts by mass or less, for example, 0.3 parts by mass or more and 8 parts by mass or less, or for example, 0.4 parts by mass or more and 5 parts by mass or less. When the amount of the binder used is 0.1 parts by mass or more, sufficient binding property can be obtained. In addition, the dispersion stability of the active material and the like can be secured, and a uniform mixture layer can be formed. When the amount of the binder used is 20 parts by mass or less, the present composition does not have a high viscosity, and the coatability to the current collector can be secured. As a result, a mixture layer having a uniform and smooth surface can be formed.

An amount of the polyfunctional crosslinking agent used in the present composition is, for example, 0.01 parts by mass or more and 45 parts by mass or less relative to 100 parts by mass of a total amount of the present binder. The use amount is, for example, 0.1 parts by mass or more and 20 parts by mass or less, for example, 0.5 parts by mass or more and 10 parts by mass or less, or for example, 1 part by mass or more and 5 parts by mass or less. In particular, when the amount of the polyfunctional crosslinking agent used is 0.5 parts by mass or more, the crosslinked structure between the present polymers is sufficiently formed by the reaction between the keto group in the present polymer and the polyfunctional crosslinking agent, and the toughness of the binder coating film after immersion in the electrolytic solution, the electrolytic solution resistance of the secondary battery electrode mixture layer, and the cycle characteristics of the secondary battery can be improved. Further, when the amount of the polyfunctional crosslinking agent used is 5 parts by mass or less, an amount of unreacted polyfunctional crosslinking agent is reduced, and the toughness of the binder coating film after immersion in the electrolytic solution, the electrolytic solution resistance of the secondary battery electrode mixture layer, and the cycle characteristics of the secondary battery can be improved. The range of the amount of the polyfunctional crosslinking agent used can be a range in which the lower limits and the upper limits are appropriately combined.

In addition, from the viewpoint that the toughness of the binder coating film after immersion in the electrolytic solution, the electrolytic solution resistance of the secondary battery electrode mixture layer, and the cycle characteristics of the secondary battery can be exhibited, the amount (number of moles) of the polyfunctional crosslinking agent used is preferably 0.01 to 10 moles, more preferably 0.05 to 7.5 moles, still more preferably 0.1 to 5 moles, still more preferably 0.25 to 2.5 moles, and yet still more preferably 0.5 to 1.5 moles relative to 1.0 mole of the keto groups in the present binder. The range of the amount of the polyfunctional crosslinking agent used can be a range in which the lower limits and the upper limits are appropriately combined.

Among the above active materials, as a positive electrode active material, a lithium salt of a transition metal oxide can be used, and for example, layered rock salt-type and spinel-type lithium-containing metal oxides can be used. Examples of specific compounds of the layered rock salt-type positive electrode active material include lithium cobaltate, lithium nickelate, and NCM{Li(Niₓ,Co_{y},Mn_{z}), x+y+z=1} and NCA{Li(Ni_{1-a-b}CoₐAl_{b})} which are called ternary systems. Further, examples of the spinel-type positive electrode active material include lithium manganate. In addition to the oxides, phosphate, silicate, sulfur, and the like are used, and examples of the phosphate include olivine-type lithium iron phosphate. As the positive electrode active material, one of the above-described ones may be used alone, or two or more thereof may be used in combination as a mixture or a composite.

Note that when the positive electrode active material containing the layered rock salt-type lithium-containing metal oxide is dispersed in water, lithium ions on the surface of the active material and hydrogen ions in water are exchanged, and thus the dispersion exhibits alkalinity. Therefore, there is a risk that aluminum foil (Al) or the like which is a general current collector material for a positive electrode is corroded. In such a case, it is preferable to neutralize the alkali content eluted from the active material by using the unneutralized or partially neutralized present polymer as the binder. In addition, the amount of the present polymer which is unneutralized or partially neutralized is preferably used such that an amount of unneutralized carboxyl groups in the present polymer is equal to or more than an equivalent amount relative to an amount of alkali eluted from the active material.

Since all of the positive electrode active materials have low electrical conductivity, a conductive auxiliary agent is generally added and used. Examples of the conductive auxiliary agent include carbon-based materials such as carbon black, carbon nanotube, carbon fiber, graphite fine powder, and carbon fiber, and among these, carbon black, carbon nanotube, and carbon fiber are preferable from the viewpoint of easily obtaining excellent conductivity. Further, as the carbon black, Ketjen black and acetylene black are preferable. As the conductive auxiliary agent, one of the above-described ones may be used alone, or two or more thereof may be used in combination. From the viewpoint of achieving both conductivity and energy density, an amount of the conductive auxiliary agent used can be, for example, 0.2 to 20 parts by mass, or for example, 0.2 to 10 parts by mass relative to 100 parts by mass of the total amount of the active material. Further, the positive electrode active material may be surface-coated with a conductive carbon-based material.

On the other hand, examples of a negative electrode active material include a carbon-based material, a lithium metal, a lithium alloy, a metal oxide, and the like, and one or two or more thereof can be used in combination. Among them, the active materials (hereinafter, also referred to as “carbon-based active materials”) made of carbon-based materials such as natural graphite, artificial graphite, hard carbon, and soft carbon are preferable, and graphites such as natural graphite and artificial graphite, and the hard carbon are more preferable. In addition, in the case of graphite, spheroidized graphite is suitably used from the viewpoint of battery performance, and a preferable range of the particle size is, for example, 1 to 20 μm, or for example, 5 to 15 μm. In addition, in order to increase the energy density, a metal, a metal oxide, or the like, capable of absorbing lithium, such as silicon or tin can be used as the negative electrode active material. Among them, silicon has a higher capacity than graphite, and an active material made of a silicon-based material (hereinafter, also referred to as “silicon-based active material”) such as silicon, a silicon alloy, and a silicon oxide such as silicon monoxide (SiO) can be used. However, the silicon-based active material has a high capacity but has a large volume change due to charging and discharging. Therefore, it is preferable to use the carbon-based active material in combination. In this case, when a blending amount of the silicon-based active material is large, the electrode material may collapse, and the cycle characteristics (durability) may be greatly deteriorated. From such a viewpoint, when the silicon-based active material is used in combination, the use amount is, for example, 60 mass % or less, or for example, 30 mass % or less relative to the carbon-based active material.

Since the carbon-based active material itself has good electrical conductivity, it is not always necessary to add the conductive auxiliary agent. When the conductive auxiliary agent is added for the purpose of further reducing the resistance, or the like, the use amount is, for example, 10 parts by mass or less, or for example, 5 parts by mass or less relative to 100 parts by mass of the total amount of the active material from the viewpoint of the energy density.

When the present composition is in a slurry state, the amount of the active material used is, for example, in the range of 10 to 75 mass %, or for example, in the range of 30 to 65 mass % relative to the total amount of the present composition. When the amount of the active material used is 10 mass % or more, migration of the binder and the like is suppressed, and it is also advantageous in terms of the drying cost of the medium. On the other hand, when the amount of the active material used is 75 mass % or less, the fluidity and the coatability of the present composition can be secured, and a uniform mixture layer can be formed.

The present composition uses water as the medium. In addition, for the purpose of adjusting properties, drying properties, and the like of the present composition, a mixed solvent with a water-soluble organic solvent such as lower alcohols such as methanol and ethanol, carbonates such as ethylene carbonate, ketones such as acetone, tetrahydrofuran, or N-methyl-2-pyrrolidone may be used. A ratio of water in a mixed medium is, for example, 50 mass % or more, or for example, 70 mass % or more.

When the present composition is brought into a coatable slurry state, the content of the medium containing water in the entire present composition can be, for example, in the range of 25 to 60 mass %, or for example, 35 to 60 mass % from the viewpoint of the coatability of the slurry, the energy cost required for drying, and productivity.

The present composition may further contain other binder components such as styrene-butadiene rubber (SBR)-based latex, carboxymethylcellulose (CMC), acrylic latex, and polyvinylidene fluoride latex in combination. When another binder component is used in combination, the use amount can be, for example, 0.1 to 5 parts by mass or less, for example, 0.1 to 2 parts by mass or less, or for example, 0.1 to 1 part by mass or less relative to 100 parts by mass of the total amount of the active material. When an amount of the other binder component used exceeds 5 parts by mass, the resistance may increase, and the high-rate characteristics may be insufficient. Among the above, SBR-based latex and CMC are preferable, and it is more preferable to use the SBR-based latex and the CMC in combination from the viewpoint that the balance between the binding property and the bending resistance is excellent.

The SBR-based latex refers to an aqueous dispersion of a copolymer having a structural unit derived from an aromatic vinyl monomer such as styrene and a structural unit derived from an aliphatic conjugated diene-based monomer such as 1,3-butadiene. Examples of the aromatic vinyl monomer include α-methylstyrene, vinyltoluene, and divinylbenzene in addition to styrene, and one or two or more thereof can be used. The structural unit derived from the aromatic vinyl monomer in the copolymer can be, for example, in the range of 20 to 70 mass %, or for example, in the range of 30 to 60 mass % mainly from the viewpoint of the binding property.

Examples of the aliphatic conjugated diene-based monomer include 2-methyl-1,3-butadiene, 2,3-dimethyl-1,3-butadiene, and 2-chloro-1,3-butadiene in addition to 1,3-butadiene, and one or two or more thereof can be used. The structural unit derived from the aliphatic conjugated diene-based monomer in the copolymer can be, for example, in the range of 30 to 70 mass %, or for example, in the range of 40 to 60 mass % from the viewpoint that the binding property of the binder and flexibility of the resulting electrode are good.

Regarding the styrene-butadiene-based latex, in order to further improve performance such as the binding property, in addition to the above-described monomers, a nitrile group-containing monomer such as (meth)acrylonitrile, a carboxyl group-containing monomer such as (meth)acrylic acid, itaconic acid, or maleic acid, or an ester group-containing monomer such as methyl (meth)acrylate, as another monomer, may be used as a copolymer monomer.

The structural unit derived from the other monomer in the copolymer can be, for example, in the range of 0 to 30 mass %, or for example, in the range of 0 to 20 mass %.

The CMC refers to a substituted product obtained by substituting a nonionic cellulose-based semi-synthetic polymer compound with a carboxymethyl group, and a salt thereof. Examples of the nonionic cellulose-based semi-synthetic polymer compound include: alkyl celluloses such as methyl cellulose, methyl ethyl cellulose, ethyl cellulose, and microcrystalline cellulose; and hydroxyalkyl celluloses such as hydroxyethyl cellulose, hydroxybutyl methyl cellulose, hydroxypropyl cellulose, hydroxypropyl methyl cellulose, hydroxyethyl methyl cellulose, hydroxypropyl methyl cellulose stearoxy ether, carboxymethyl hydroxyethyl cellulose, alkyl hydroxyethyl cellulose, and nonoxynyl hydroxyethyl cellulose.

The composition for the secondary battery electrode mixture layer of the present invention contains the binder, the polyfunctional crosslinking agent, the active material, and water as essential components, and is obtained by mixing the components using known means. A method for mixing the components is not particularly limited, and a known method can be adopted, but a method is preferable in which powder components such as the active material, the conductive auxiliary agent, and the binder are dry-blended, then mixed with a dispersion medium such as water, and dispersed and kneaded. When the present composition is obtained in the slurry state, it is preferable to finish the composition into a slurry having no poor dispersion or aggregation. As a mixing means, a known mixer such as a planetary mixer, a thin film swirling mixer, or a rotation-revolution mixer can be used, but it is preferable to use the thin film swirling mixer from the viewpoint that a good dispersion state can be obtained in a short time. In addition, in the case of using the thin film swirling mixer, it is preferable to perform preliminary dispersion in advance with a stirrer such as a disperser. The pH of the slurry is not particularly limited as long as the effect of the present invention is obtained, but is preferably less than 12.5, and for example, in a case of blending the CMC, the pH is more preferably less than 11.5 and still more preferably less than 10.5 from the viewpoint that concern of hydrolysis of the CMC is small. Further, the viscosity of the slurry is not particularly limited as long as the effect of the present invention is obtained, but the B-type viscosity (25° C.) at 20 rpm can be, for example, in the range of 100 to 6,000 mPa·s, for example, in the range of 500 to 5,000 mPa·s, or for example, in the range of 1,000 to 4,000 mPa·s. When the viscosity of the slurry is within the above range, good coatability can be secured.

### 5. Secondary Battery Electrode

The secondary battery electrode of the present invention includes a mixture layer formed from the composition for the secondary battery electrode mixture layer of the present invention on the surface of a current collector such as copper, aluminum, or the like. The mixture layer is formed by applying the present composition to the surface of the current collector and then drying and removing a medium such as water. The method for applying the present composition is not particularly limited, and known methods such as a doctor blade method, a dip method, a roll coating method, a comma coating method, a curtain coating method, a gravure coating method, and an extrusion method can be employed. Further, the drying can be performed by a known method such as warm air blowing, decompression, (far) infrared ray irradiation, or microwave irradiation.

Usually, the mixture layer obtained after drying is subjected to compression treatment by a die press, a roll press, or the like. By compressing, the active material and the binder can be brought into close contact with each other, and strength of the mixture layer and adhesion to the current collector can be improved. A thickness of the mixture layer can be adjusted to, for example, about 30 to 80% of that before compression by compression, and the thickness of the mixture layer after the compression is generally about 4 to 200 μm.

### 6. Secondary Battery

The secondary battery can be produced by providing the secondary battery electrode of the present invention with a separator and an electrolytic solution. The electrolytic solution may be liquid or gel.

The separator is disposed between the positive electrode and the negative electrode of the battery, and plays a role of preventing a short circuit due to contact between both electrodes and holding the electrolytic solution to secure ion conductivity. The separator is preferably a film-like insulating microporous membrane having good ion permeability and mechanical strength. As a specific material, polyolefins such as polyethylene and polypropylene, polytetrafluoroethylene, and the like can be used.

As the electrolytic solution, a generally used known electrolytic solution can be used depending on the type of the active material. In a lithium ion secondary battery, specific solvents include cyclic carbonates having a high dielectric constant and a high electrolyte dissolving ability such as propylene carbonate and ethylene carbonate, and chain carbonates having a low viscosity such as ethyl methyl carbonate, dimethyl carbonate, and diethyl carbonate, and these can be used alone or as a mixed solvent. The electrolytic solution is used by dissolving a lithium salt such as LiPF₆, LiSbF₆, LiBF₄, LiClO₄, or LiAlO₄ in these solvents. In a nickel-hydride secondary battery, a potassium hydroxide aqueous solution can be used as the electrolytic solution. The secondary battery is obtained by forming a positive electrode plate and a negative electrode plate separated by the separator into a spiral or laminated structure and storing them in a case or the like.

The binder for the secondary battery electrode disclosed in the present specification is excellent in the toughness of the binder coating film after immersion in the electrolytic solution, and the secondary battery electrode composite layer obtained using the electrode slurry containing the binder exhibits the electrolytic solution resistance. Furthermore, the secondary battery including an electrode obtained using the binder can ensure good integrity and exhibits good durability (cycle characteristics) even when charging and discharging are repeated, and thus is suitable for a vehicle-mounted secondary battery and the like.

### EXAMPLES

Hereinafter, the present invention will be specifically described based on Examples. Note that the present invention is not limited to these Examples. Note that in the following description, “parts” and “%” respectively mean parts by mass and mass % unless otherwise specified.

In the following examples, carboxyl group-containing polymer salt was evaluated by the following method.

### «Manufacturing of Carboxyl Group-Containing Polymer Salt»

### (Measurement of Particle Diameter (Water-Swelling Particle Diameter) in Aqueous Medium)

0.25 g of a powder of carboxyl group-containing crosslinked polymer salt and 49.75 g of ion-exchanged water were weighed in a 100 cc container and set in a rotation-revolution mixer (Awatori Rentaro AR-250 manufactured by THINKY CORPORATION). Subsequently, stirring (rotation speed: 2,000 rpm/revolution speed: 800 rpm, 7 minutes) and further defoaming (rotation speed 2,200 rpm/revolution speed 60 rpm, 1 minute) treatment were performed to prepare a hydrogel in which the carboxyl group-containing crosslinked polymer salt was swollen in water.

Subsequently, particle size distribution of the hydrogel was measured with a laser diffraction/scattering particle size distribution analyzer (Microtrac MT-3300EXII manufactured by MicrotracBell Corp.) using ion-exchanged water as the dispersion medium. When an amount of the hydrogel capable of obtaining an appropriate scattered light intensity was charged while an excessive amount of the dispersion medium was circulated relative to the hydrogel, a particle size distribution shape measured after several minutes was stabilized. As soon as the stability was confirmed, the particle size distribution was measured to obtain the volume-based median diameter (D50) as a representative value of the particle diameter.

### (Manufacturing Example 1: Manufacturing of Carboxyl Group-Containing Polymer Salt R-1)

For the polymerization, a reactor equipped with a stirring blade, a thermometer, a reflux condenser, and a nitrogen inlet tube was used.

Into the reactor were charged 567 parts of acetonitrile, 2.2 parts of ion-exchanged water, 96 parts of acrylic acid (hereinafter, referred to as “AA”), 4 parts of diacetone acrylamide, 0.9 parts of trimethylolpropane diallyl ether (trade name “Neoallyl T-20” manufactured by Osaka Soda Co., Ltd.), and triethylamine corresponding to 1.0 mol % relative to the above AA. An inside of the reactor was sufficiently purged with nitrogen, and then heated to raise an internal temperature to 55° C. After confirming that the internal temperature was stabilized at 55° C., 0.040 parts of 2,2′-azobis (2,4-dimethylvaleronitrile) (trade name “V-65” manufactured by FUJIFILM Wako Pure Chemical Corporation) was added as a polymerization initiator, and since white turbidity was observed in a reaction solution, this point was defined as a polymerization initiation point. Monomer concentration was calculated to be 15%. Cooling of the polymerization reaction solution was started when 12 hours had elapsed from the polymerization initiation point, and after the internal temperature was lowered to 25° C., 50.3 parts of a powder of lithium hydroxide monohydrate (hereinafter, referred to as “LiOH·H₂O”) was added. After the addition, stirring was continued at room temperature for 12 hours to obtain a slurry-like polymerization reaction solution in which particles of carboxyl group-containing polymer salt R-1 (lithium salt, degree of neutralization: 90 mol %) were dispersed in the medium.

The obtained polymerization reaction solution was centrifuged to precipitate the polymer, and then supernatant was removed. Thereafter, a washing operation in which the precipitate was redispersed in acetonitrile having the same weight as the polymerization reaction solution, and then polymer particles were precipitated by centrifugation to remove the supernatant was repeated twice. The precipitate was collected and dried at 80° C. for 3 hours under reduced pressure conditions to remove volatiles, thereby obtaining a powder of carboxyl group-containing polymer salt R-1. Since the carboxyl group-containing polymer salt R-1 had hygroscopicity, it was hermetically stored in a container having a water vapor barrier property. Note that when the powder of carboxyl group-containing polymer salt R-1 was subjected to IR measurement, and the degree of neutralization was determined from an intensity ratio of a peak derived from C═O group of the carboxylic acid and a peak derived from C═O of lithium carboxylate, the degree of neutralization was 90 mol % which was equal to a calculated value from the charged amount. Further, the particle diameter in the aqueous medium was 1.52 μm.

### (Manufacturing Example 2: Manufacturing of Carboxyl Group-Containing Polymer Salt R-2)

The charged amount of each raw material was as shown in Table 1, and the same operation as in Manufacturing Example 1 was carried out except that diacetone acrylamide was added 7 hours after polymerization initiation (in the middle of a polymerization process corresponding to a time point of 0.58T) to obtain a polymerization reaction solution containing carboxyl group-containing polymer salt R-2.

Subsequently, each polymerization reaction solution was subjected to the same operation as in Manufacturing Example 1 to obtain the carboxyl group-containing polymer salt R-2 in a powder form. Each carboxyl group-containing polymer salt was hermetically stored in a container having a water vapor barrier property.

Physical property values of the obtained polymer salts were measured in the same manner as in Manufacturing Example 1, and the results are shown in Table 1.

### (Manufacturing Examples 3 to 12 and Comparative Manufacturing Examples 1 and 2: Manufacturing of Carboxyl Group-Containing Polymer Salts R-3 to R-14)

The same operations as in Manufacturing Example 1 were carried out except that the type and charged amount of each raw material were as shown in Table 1 to obtain polymerization reaction solutions containing carboxyl group-containing polymer salts R-3 to R-14.

Subsequently, each polymerization reaction solution was subjected to the same operation as in Manufacturing Example 1 to obtain the carboxyl group-containing polymer salts R-3 to R-14 in powder form. Each containing polymer salt was hermetically stored in a container having a water vapor barrier property.

Physical property values of the obtained polymer salts were measured in the same manner as in Manufacturing Example 1, and the results are shown in Table 1.

TABLE 1

| | | | Manufacturing Example/Comparative Manufacturing Example No. | | | | | | | |
|---|---|---|---|---|---|---|---|---|---|---|
| | | | Manufac- | Manufac- | Manufac- | Manufac- | Manufac- | Manufac- | Manufac- | Manufac- |
| | | | turing | turing | turing | turing | turing | turing | turing | turing |
| | | | Example 1 | Example 2 | Example 3 | Example 4 | Example 5 | Example 6 | Example 7 | Example 8 |
| Carboxyl group-containing polymer salt | | | R-1 | R-2 | R-3 | R-4 | R-5 | R-6 | R-7 | R-8 |
| Charged | Ethylenically | AA | 96.0 | 96.0 | 50.0 | 80.0 | 99.0 | 60.0 | 30.0 | 96.0 |
| amount | unsaturated | | | | | | | | | |
| [parts] | carboxylic acid | | | | | | | | | |
| | monomer (a) | | | | | | | | | |
| | Another | HEAA | | | 46.0 | 16.0 | | | | |
| | monomer (c) | | | | | | | | | |
| | Keto group- | DAAM | 4.0 | 4.0 | 4.0 | 4.0 | 1.0 | 40.0 | 70.0 | |
| | containing | AAEM | | | | | | | | 4.0 |
| | ethylenically | Addition | initial | middle | initial | initial | initial | initial | initial | initial |
| | unsaturated | timing | | (0.58 T) | | | | | | |
| | monomer (b) | | | | | | | | | |
| | Crosslinkable | T-20[parts] | 0.9 | 0.9 | 0.9 | 0.9 | 0.9 | 0.9 | 0.9 | 0.9 |
| | monomer | Used amount | 0.3 | 0.3 | 0.4 | 0.3 | 0.3 | 0.4 | 0.5 | 0.3 |
| | | [mol %] | | | | | | | | |
| | Basic | TEA [mol %] | 1.0 | 1.0 | 1.0 | 1.0 | 1.0 | 1.0 | 1.0 | 1.0 |
| | compound | | | | | | | | | |
| | Polymerization | Ion-exchanged | 2.2 | 2.2 | 2.2 | 2.2 | 2.2 | 2.2 | 2.2 | 2.2 |
| | solvent | water | | | | | | | | |
| | | Acetonitrile | 567 | 567 | 567 | 567 | 567 | 567 | 567 | 567 |
| | Polymerization | V-65 | 0.040 | 0.040 | 0.040 | 0.040 | 0.040 | 0.040 | 0.040 | 0.040 |
| | initiator | | | | | | | | | |
| | Process | LiOH•H₂O | 50.3 | 50.3 | 26.2 | 41.9 | 51.9 | 31.4 | 15.7 | 50.3 |
| | neutralization | Na₂CO₃ | | | | | | | | |
| | | K₂CO₃ | | | | | | | | |

| Initial monomer concentration [mass %] | | 15% | 15% | 15% | 15% | 15% | 15% | 15% | 15% |
|---|---|---|---|---|---|---|---|---|---|
| Neutral- | Type | Li | Li | Li | Li | Li | Li | Li | Li |
| ized salt | Degree of neutralization [mol %] | 90 | 90 | 90 | 90 | 90 | 90 | 90 | 90 |

| | | | | | | | | |
|---|---|---|---|---|---|---|---|---|
| Water-swelling particle diameter [μm] | 1.52 | 1.54 | 2.64 | 1.54 | 1.53 | 1.29 | 1.30 | 1.49 |

| | | | Manufacturing Example/Comparative Manufacturing Example No. | | | | | |
|---|---|---|---|---|---|---|---|---|
| | | | Manufac- | Manufac- | Manufac- | Manufac- | Comparative | Comparative |
| | | | turing | turing | turing | turing | Manufacturing | Manufacturing |
| | | | Example 9 | Example 10 | Example 11 | Example 12 | Example 1 | Example 2 |
| Carboxyl group-containing polymer salt | | | R-9 | R-10 | R-11 | R-12 | R-13 | R-14 |
| Charged | Ethylenically | AA | 96.0 | 96.0 | 96.0 | 96.0 | 10.0 | 30.0 |
| amount | unsaturated | | | | | | | |
| [parts] | carboxylic acid | | | | | | | |
| | monomer (a) | | | | | | | |
| | Another | HEAA | | | | | 86.0 | 70.0 |
| | monomer (c) | | | | | | | |
| | Keto group- | DAAM | 4.0 | 4.0 | 4.0 | 4.0 | 4.0 | |
| | containing | AAEM | | | | | | |
| | ethylenically | Addition | initial | initial | initial | initial | initial | initial |
| | unsaturated | timing | | | | | | |
| | monomer (b) | | | | | | | |
| | Crosslinkable | T-20 [parts] | 0.9 | 0.9 | 0.9 | 0.0 | 0.9 | 0.9 |
| | monomer | Used amount | 0.3 | 0.3 | 0.3 | 0.0 | 0.5 | 0.4 |
| | | [mol %] | | | | | | |
| | Basic | TEA [mol %] | 1.0 | 1.0 | 1.0 | 1.0 | 1.0 | 1.0 |
| | compound | | | | | | | |
| | Polymerization | Ion-exchanged | 2.2 | 2.2 | 2.2 | 2.2 | 2.2 | 2.2 |
| | solvent | water | | | | | | |
| | | Acetonitrile | 567 | 567 | 567 | 567 | 567 | 567 |
| | Polymerization | V-65 | 0.040 | 0.040 | 0.040 | 0.040 | 0.040 | 0.040 |
| | initiator | | | | | | | |
| | Process | LiOH•H₂O | 39.1 | | | 50.3 | 5.2 | 15.7 |
| | neutralization | Na₂CO₃ | | 64.2 | | | | |
| | | K₂CO₃ | | | 83.3 | | | |

| Initial monomer concentration [mass %] | | 15% | 15% | 15% | 15% | 15% | 15% |
|---|---|---|---|---|---|---|---|
| Neutral- | Type | Li | Na | K | Li | Li | Li |
| ized salt | Degree of neutralization [mol %] | 70 | 90 | 90 | 90 | 90 | 90 |

| | | | | | | |
|---|---|---|---|---|---|---|
| Water-swelling particle diameter [μm] | 1.58 | 1.55 | 1.51 | dissolved | 13.2 | 1.31 |

Details of compounds used in Table 1 are shown below.
AA: acrylic acid
HEAA: N-hydroxyethyl acrylamide
DAAM: diacetone acrylamide
AAEM: acetoacetoxyethyl methacrylate
T-20: trimethylolpropane diallyl ether (trade name “Neoallyl T-20” manufactured by Osaka Soda Co., Ltd.)
TEA: triethylamine
V-65: 2,2′-azobis (2,4-dimethylvaleronitrile) (manufactured by FUJIFILM Wako Pure Chemical Corporation)
LiOH·H₂O: lithium hydroxide monohydrate
Na₂CO₃: sodium carbonate
K₂CO₃: potassium carbonate

### Example 1

### (Preparation of Binder Coating Film)

The carboxyl group-containing polymer salt R-1, the styrene-butadiene-based latex (SBR, the sodium carboxymethylcellulose (CMC), the adipic acid dihydrazide, and the ion-exchanged water were added in a container in the parts shown in Table 2, and mixed, and then predispersion was performed with a disperser, and then, this dispersion was performed for 15 seconds under the condition of a circumferential speed of 20 m/see using a thin film swirling mixer (manufactured by PRIMIX Corporation, FM-56-30) to obtain a binder aqueous solution.

Thereafter, the binder aqueous solution was poured into a disposable tray, air-dried at room temperature for one week, dried at 40° C. overnight, and further vacuum-dried at 80° C. for 12 hours.

The binder coating film obtained after drying was punched into a size of 1.0 cm×6.0 cm to prepare a test piece, and the toughness and the electrolytic solution resistance were measured.

### <Toughness of Binder Coating Film>

A test piece prepared by punching out the binder coating film was subjected to a tensile test at a speed of 10 mm/min using a tensile tester (Tensilon, RTC-1210A manufactured by Orientec Co., Ltd.), and Young's modulus [MPa] was measured. As a result, the Young's modulus was 23.9 MPa.

Further, the test piece used in evaluation of swellability of the electrolytic solution was also subjected to a tensile test under the same conditions to measure the Young's modulus. As a result, the Young's modulus was 14.7 MPa, and the toughness based on the following criteria was evaluated as “A”.

Note that as the Young's modulus of the binder coating film after immersion in the electrolytic solution is higher, the toughness of the electrode composite layer is more excellent, and the cycle characteristics can be improved.

### (Evaluation Criteria for Toughness)

A: Young's modulus after immersion in electrolytic solution is 14.0 MPa or more
B: Young's modulus after immersion in electrolytic solution is 12.0 MPa or more and less than 14.0 MPa
C: Young's modulus after immersion in electrolytic solution is less than 12.0 MPa

### <Electrolytic Solution Resistance of Binder Coating Film>

The test piece obtained as described above was immersed in an electrolytic solution mixed at a mass ratio of ethylene carbonate (EC):dimethyl carbonate (DMC)=1:3 and left standing at 40° C. for 2 hours, then the test piece was taken out from the electrolytic solution, the surface was wiped off, and the electrolytic solution swelling degree was measured.

Here, a method for measuring the electrolytic solution swelling degree will be described below.

When weights of the test piece before and after immersion in the electrolytic solution were respectively defined as [W₀ (g)] and [W₁ (g)], the electrolytic solution swelling degree was determined by the following formula.

Electrolytic solution swelling degree(mass %)=(W₁)/(W₀)×100

According to the above formula, the electrolytic solution swelling degree was 115%, and the electrolytic solution resistance based on the following criteria was evaluated as “A”.

Note that as the electrolytic solution swelling degree of the binder coating film is lower, the electrode composite layer is less likely to absorb components of the electrolytic solution and is less likely to swell in the electrolytic solution.

### (Evaluation Criteria for Electrolytic Solution Resistance)

A: Electrolytic solution swelling degree is less than 120%
B: Electrolytic solution swelling degree is 120% or more and less than 125%
C: Electrolytic solution swelling degree is 125% or more

### Examples 2 to 15 and Comparative Examples 1 to 3

A binder coating film was produced in the same manner as in Example 1 except that formulation was as shown in Table 2, and the toughness and the electrolytic solution resistance were evaluated. The results are shown in Table 2.

TABLE 2

| | | | | Example/Comparative Example No. | | | | | | |
|---|---|---|---|---|---|---|---|---|---|---|
| | | | | Example | Example | Example | Example | Example | Example | Example |
| | | | | 1 | 2 | 3 | 4 | 5 | 6 | 7 |
| Composition | Binder | Carboxyl | Type | R-1 | R-2 | R-3 | R-4 | R-5 | R-6 | R-7 |
| for binder | | group-containing | Parts | 1.0 | 1.0 | 1.0 | 1.0 | 1.0 | 1.0 | 1.0 |
| coating film | | polymer salt | | | | | | | | |
| | | SBR | Parts | 2.0 | 2.0 | 2.0 | 2.0 | 2.0 | 2.0 | 2.0 |
| | | CMC | Parts | 1.0 | 1.0 | 1.0 | 1.0 | 1.0 | 1.0 | 1.0 |
| | Polyfunctional | ADH | Parts | 0.021 | 0.021 | 0.021 | 0.021 | 0.005 | 0.206 | 0.360 |
| | crosslinking | SDH | Parts | | | | | | | |
| | agent | Number of moles of | | 1.0 | 1.0 | 1.0 | 1.0 | 1.0 | 1.0 | 1.0 |
| | | functional group in | | | | | | | | |
| | | polyfunctional crosslinking | | | | | | | | |
| | | agent relative to 1 mol of | | | | | | | | |
| | | keto group in polymer | | | | | | | | |
| | Ion-exchanged water | | | 130 | 130 | 130 | 130 | 130 | 140 | 150 |
| | Total charged amount | | | 134.0 | 134.0 | 134.0 | 134.0 | 134.0 | 144.2 | 154.4 |
| | Solid content concentration [mass %] | | | 2.0% | 2.0% | 2.0% | 2.0% | 2.0% | 2.0% | 2.0% |
| Evaluation | Toughness | Young's modulus before | | 23.9 | 25.2 | 23.5 | 23.8 | 23.4 | 24.5 | 24.7 |
| results | of binder | immersion in electrolytic | | | | | | | | |
| | coating film | solution [MPa] | | | | | | | | |
| | | Young's modulus after | | 14.7 | 15.7 | 14.0 | 14.4 | 14.2 | 14.2 | 13.9 |
| | | immersion in electrolytic | | | | | | | | |
| | | solution [MPa] | | | | | | | | |
| | | Evaluation | | A | A | A | A | A | A | B |
| | Electrolytic | Electrolytic solution | | 115% | 112% | 119% | 116% | 118% | 121% | 124% |
| | solution | swelling degree [%] | | | | | | | | |
| | resistance | Evaluation | | A | A | A | A | A | B | B |
| | of binder | | | | | | | | | |
| | coating film | | | | | | | | | |

| | | | | Example/Comparative Example No. | | | | | |
|---|---|---|---|---|---|---|---|---|---|
| | | | | Example | Example | Example | Example | Example | Example |
| | | | | 8 | 9 | 10 | 11 | 12 | 13 |
| Composition | Binder | Carboxyl | Type | R-8 | R-9 | R-10 | R-11 | R-12 | R-1 |
| for binder | | group-containing | | | | | | | |
| coating film | | polymer salt | Parts | 1.0 | 1.0 | 1.0 | 1.0 | 1.0 | 1.0 |
| | | SBR | Parts | 2.0 | 2.0 | 2.0 | 2.0 | 2.0 | 2.0 |
| | | CMC | Parts | 1.0 | 1.0 | 1.0 | 1.0 | 1.0 | 1.0 |
| | Polyfunctional | ADH | Parts | 0.021 | 0.021 | 0.021 | 0.021 | 0.021 | 0.011 |
| | crosslinking | SDH | Parts | | | | | | |
| | agent | Number of moles of | | 1.0 | 1.0 | 1.0 | 1.0 | 1.0 | 2.0 |
| | | functional group in | | | | | | | |
| | | polyfunctional crosslinking | | | | | | | |
| | | agent relative to 1 mol of | | | | | | | |
| | | keto group in polymer | | | | | | | |
| | Ion-exchanged water | | | 130 | 130 | 130 | 130 | 130 | 133 |
| | Total charged amount | | | 134.0 | 134.0 | 134.0 | 134.0 | 134.0 | 137.0 |
| | Solid content concentration [mass %] | | | 2.0% | 2.0% | 2.0% | 2.0% | 2.0% | 2.0% |
| Evaluation | Toughness | Young's modulus before | | 23.5 | 23.8 | 23.7 | 23.5 | 23.1 | 23.5 |
| results | of binder | immersion in electrolytic | | | | | | | |
| | coating film | solution [MPa] | | | | | | | |
| | | Young's modulus after | | 14.4 | 14.6 | 14.7 | 14.7 | 12.8 | 14.4 |
| | | immersion in electrolytic | | | | | | | |
| | | solution [MPa] | | | | | | | |
| | | Evaluation | | A | A | A | A | B | A |
| | Electrolytic | Electrolytic solution | | 117% | 116% | 116% | 117% | 120% | 118% |
| | solution | swelling degree [%] | | | | | | | |
| | resistance | Evaluation | | A | A | A | A | B | A |
| | of binder | | | | | | | | |
| | coating film | | | | | | | | |

| | | | | Example/Comparative Example No. | | | | |
|---|---|---|---|---|---|---|---|---|
| | | | | | | Compar- | Compar- | Compar- |
| | | | | | | ative | ative | ative |
| | | | | Example | Example | Example | Example | Example |
| | | | | 14 | 15 | 1 | 2 | 3 |
| Composition | Binder | Carboxyl | Type | R-1 | R-1 | R-13 | R-14 | R-1 |
| for binder | | group-containing | | | | | | |
| coating film | | polymer salt | Parts | 1.0 | 1.0 | 1.0 | 1.0 | 1.0 |
| | | SBR | Parts | 2.0 | 2.0 | 2.0 | 2.0 | 2.0 |
| | | CMC | Parts | 1.0 | 1.0 | 1.0 | 1.0 | 1.0 |
| | Polyfunctional | ADH | Parts | 0.010 | | 0.021 | 0.021 | |
| | crosslinking | SDH | Parts | | 0.017 | | | |

| | agent | Number of moles of | 0.5 | 1.0 | 1.0 | 0.0 | 0.0 |
|---|---|---|---|---|---|---|---|
| | | functional group in | | | | | |
| | | polyfunctional crosslinking | | | | | |
| | | agent relative to 1 mol of | | | | | |
| | | keto group in polymer | | | | | |
| | Ion-exchanged water | | 130 | 130 | 130 | 130 | 130 |
| | Total charged amount | | 134.0 | 134.0 | 134.0 | 134.0 | 134.0 |
| | Solid content concentration [mass %] | | 2.0% | 2.0% | 2.0% | 2.0% | 2.0% |
| Evaluation | Toughness | Young's modulus before | 23.6 | 23.3 | 20.9 | 22.7 | 23.0 |
| results | of binder | immersion in electrolytic | | | | | |
| | coating film | solution [MPa] | | | | | |
| | | Young's modulus after | 14.2 | 13.8 | 9.8 | 10.8 | 11.8 |
| | | immersion in electrolytic | | | | | |
| | | solution [MPa] | | | | | |
| | | Evaluation | A | B | C | C | C |
| | Electrolytic | Electrolytic solution | 117% | 119% | 128% | 132% | 120% |
| | solution | swelling degree [%] | | | | | |
| | resistance | Evaluation | A | A | C | C | B |

of binder
coating film

Details of compounds used in Table 2 are shown below.
CMC: sodium carboxymethylcellulose
SBR: styrene-butadiene rubber
ADH: adipic acid dihydrazide
SDH: succinic acid dihydrazide

### Example 1

### (Preparation of Composite for Electrode Mixture Layer)

As the active material, artificial graphite (trade name “SCMG-CF” manufactured by Showa Denko K.K.) and SiO (5 μm manufactured by OSAKA Titanium technologies Co., Ltd.) were used. As the binder, a mixture of crosslinked polymer salt R-1, styrene-butadiene rubber (SBR), and sodium carboxymethylcellulose (CMC) was used. In addition, adipic acid dihydrazide (ADH) was used as the polyfunctional crosslinking agent.

Graphite, Si-based active material, R-1, SBR, CMC and ADH were added using water as a diluting solvent to a planetary mixer (HIVIS MIX 2P-03 manufactured by PRIMIX Corporation) in a mass ratio of graphite:Si-based active material:R-1:SBR:CMC:ADH=76.8:19.2:1.0:2.0:1.0:0.021 (solid content) so that solid content concentration of the composition for the electrode mixture layer was 53 mass %, and then mixed for 1 hour and 30 minutes to prepare a composition for an electrode mixture layer in a slurry state (electrode slurry).

### (Preparation of Negative Electrode Plate)

Subsequently, the electrode slurry was applied onto a current collector (copper foil) having a thickness of 16.5 μm using a variable applicator, and dried in a ventilation dryer at 80° C. for 15 minutes to form a mixture layer. Thereafter, the mixture layer was rolled so as to have a thickness of 50±5 μm and a mixture density of 1.60±0.10 g/cm³, and then punched into a size of 1.0 cm×6.0 cm for a peeling strength test and 3 cm square for battery evaluation to obtain a negative electrode plate.

### (Preparation of Positive Electrode Plate)

In an N-methylpyrrolidone (NMP) solvent, 100 parts of LiNi_{0.5}Co_{0.2}Mn_{0.3}O₂ (NCM) as the positive electrode active material and 2 parts of acetylene black were mixed and added, and 4 parts of polyvinylidene fluoride (PVDF) as a binder for a positive electrode were mixed to prepare a composition for a positive electrode composite layer. The composition for the positive electrode composite layer was applied to an aluminum current collector (thickness: 20 μm) and dried to form a mixture layer. Thereafter, the mixture layer was rolled so as to have a thickness of 125 μm and a mixture density of 3.0 g/cm³, and then punched into a 3 cm square to obtain a positive electrode plate.

### (Preparation of Electrolytic Solution)

To a mixed solvent containing ethylene carbonate (EC) and dimethyl carbonate (DMC) (EC:DMC=3:7 by volume), 1 mass % of vinylene carbonate (VC) and 2 mass % of fluoroethylene carbonate (FEC) were added, and 1.2 mol/liter of LiPF₆ was dissolved to prepare a nonaqueous electrolyte.

### (Preparation of Secondary Battery)

As for configuration of the battery, a lead terminal was attached to each of the positive electrode and the negative electrode, and electrode bodies opposed to each other with a separator (made of polyethylene: film thickness 16 μm, porosity 47%) interposed therebetween were placed in a battery exterior body using an aluminum laminate, injected with liquid, and sealed to obtain a test battery. A design capacity of this prototype battery is 50 mAh. As the design capacity of the battery, the battery was designed based on an end-of-charge voltage up to 4.2 V.

### <Evaluation of Cycle Characteristics>

The lithium ion secondary battery of a laminate type cell prepared above was subjected to a charge-discharge operation at a charge-discharge rate of 0.1 C under the condition of 2.5 to 4.2 V by CC discharge under an environment of 45° C., and an initial capacity C₀ was measured. Further, charge and discharge were repeated at a charge-discharge rate of 0.5 C under the condition of 2.5 to 4.2 V by CC discharge under an environment of 25° C., and a capacity C₅₀ after 50 cycles was measured.

Here, the cycle characteristics (ΔC) were determined by the following formula.

ΔC=C₅₀/C₀×100(%)

ΔC calculated by the above formula was 92.7%, and the cycle characteristics based on the following criteria were evaluated as “A”.

Note that as the value of ΔC is larger, the cycle characteristics are more excellent.

### (Evaluation of Cycle Characteristics)

A: Charge-discharge capacity retention rate is 92.0% or more
B: Charge-discharge capacity retention rate is 90.0% or more and less than 92.0%
C: Charge-discharge capacity retention rate is less than 90.0%

### Examples 2 to 15 and Comparative Examples 1 to 3

An electrode slurry was prepared by performing the same operation as in Example 1 except that the formulation was as described in Table 3, and the cycle characteristics of the battery of the negative electrode plate obtained using the electrode slurry were evaluated. The results are shown in Table 3.

TABLE 3

| | | | | Example/Comparative Example No. | | | | | | |
|---|---|---|---|---|---|---|---|---|---|---|
| | | | | Example | Example | Example | Example | Example | Example | Example |
| | | | | 1 | 2 | 3 | 4 | 5 | 6 | 7 |
| Composition | Active | Artificial | Parts | 76.8 | 76.8 | 76.8 | 76.8 | 76.8 | 76.8 | 76.8 |
| for electrode | material | graphite | | | | | | | | |
| mixture layer | Binder | SiO | Parts | 19.2 | 19.2 | 19.2 | 19.2 | 19.2 | 19.2 | 19.2 |
| (Electrode | | Carboxyl | Type | R-1 | R-2 | R-4 | R-5 | R-6 | R-7 | R-7 |
| slurry) | | group- | Parts | 1.0 | 1.0 | 1.0 | 1.0 | 1.0 | 1.0 | 1.0 |
| | | containing | | | | | | | | |
| | | polymer salt | | | | | | | | |
| | | SBR | Parts | 2.0 | 2.0 | 2.0 | 2.0 | 2.0 | 1.8 | 1.6 |
| | | CMC | Parts | 1.0 | 1.0 | 1.0 | 1.0 | 1.0 | 1.0 | 1.0 |
| | Polyfunctional | ADH | Parts | 0.021 | 0.021 | 0.021 | 0.021 | 0.005 | 0.206 | 0.360 |
| | crosslinking | SDH | Parts | | | | | | | |

| | agent | Number of moles of | 1.0 | 1.0 | 1.0 | 1.0 | 1.0 | 1.0 | 1.0 |
|---|---|---|---|---|---|---|---|---|---|
| | | functional group in | | | | | | | |
| | | polyfunctional | | | | | | | |
| | | crosslinking agent | | | | | | | |
| | | relative to 1 mol of | | | | | | | |
| | | keto group in polymer | | | | | | | |
| | Ion-exchanged water | | 87 | 87 | 87 | 87 | 87 | 87 | 87 |
| | Total charged amount | | 186.5 | 186.5 | 186.5 | 186.5 | 186.5 | 186.5 | 186.5 |
| | Solid content concentration [mass %] | | 53% | 53% | 53% | 53% | 53% | 53% | 53% |
| Evaluation | Cycle | Capacity retention | 92.7 | 93.7 | 91.8 | 92.6 | 92.4 | 92.4 | 92.1 |
| results | Characteristics | rate [%] | | | | | | | |
| | | Evaluation | A | A | B | A | A | A | A |

| | | | | Example/Comparative Example No. | | | | | |
|---|---|---|---|---|---|---|---|---|---|
| | | | | Example | Example | Example | Example | Example | Example |
| | | | | 8 | 9 | 10 | 11 | 12 | 13 |
| Composition | Active | Artificial | Parts | 76.8 | 76.8 | 76.8 | 76.8 | 76.8 | 76.8 |
| for electrode | material | graphite | | | | | | | |
| mixture layer | Binder | SiO | Parts | 19.2 | 19.2 | 19.2 | 19.2 | 19.2 | 19.2 |
| (Electrode | | Carboxyl | Type | R-8 | R-9 | R-10 | R-11 | R-12 | R-1 |
| slurry) | | group- | Parts | 1.0 | 1.0 | 1.0 | 1.0 | 1.0 | 1.0 |
| | | containing | | | | | | | |
| | | polymer salt | | | | | | | |
| | | SBR | Parts | 2.0 | 2.0 | 2.0 | 2.0 | 2.0 | 2.0 |
| | | CMC | Parts | 1.0 | 1.0 | 1.0 | 1.0 | 1.0 | 1.0 |
| | Polyfunctional | ADH | Parts | 0.021 | 0.021 | 0.021 | 0.021 | 0.021 | 0.041 |
| | crosslinking | SDH | Parts | | | | | | |

| | agent | Number of moles of | 1.0 | 1.0 | 1.0 | 1.0 | 1.0 | 2.0 |
|---|---|---|---|---|---|---|---|---|
| | | functional group in | | | | | | |
| | | polyfunctional | | | | | | |
| | | crosslinking agent | | | | | | |
| | | relative to 1 mol of | | | | | | |
| | | keto group in polymer | | | | | | |
| | Ion-exchanged water | | 87 | 87 | 87 | 87 | 87 | 87 |
| | Total charged amount | | 186.5 | 186.5 | 186.5 | 186.5 | 186.5 | 186.5 |
| | Solid content concentration [mass %] | | 53% | 53% | 53% | 53% | 53% | 53% |
| Evaluation | Cycle | Capacity retention | 92.3 | 92.6 | 92.3 | 92.2 | 91.5 | 92.4 |
| results | Characteristics | rate [%] | | | | | | |
| | | Evaluation | A | A | A | A | B | A |

| | | | | Example/Comparative Example No. | | | | |
|---|---|---|---|---|---|---|---|---|
| | | | | | | Compar- | Compar- | Compar- |
| | | | | | | ative | ative | ative |
| | | | | Example | Example | Example | Example | Example |
| | | | | 14 | 15 | 1 | 2 | 3 |
| Composition | Active | Artificial | Parts | 76.8 | 76.8 | 76.8 | 76.8 | 76.8 |
| for electrode | material | graphite | | | | | | |
| mixture layer | Binder | SiO | Parts | 19.2 | 19.2 | 19.2 | 19.2 | 19.2 |
| (Electrode | | Carboxyl | Type | R-1 | R-1 | R-13 | R-14 | R-1 |
| slurry) | | group- | Parts | 1.0 | 1.0 | 1.0 | 1.0 | 1.0 |
| | | containing | | | | | | |
| | | polymer salt | | | | | | |
| | | SBR | Parts | 2.0 | 2.0 | 2.0 | 2.0 | 2.0 |
| | | CMC | Parts | 1.0 | 1.0 | 1.0 | 1.0 | 1.0 |
| | Polyfunctional | ADH | Parts | 0.010 | | 0.021 | 0.021 | |
| | crosslinking | SDH | Parts | | 0.017 | | | |

| | agent | Number of moles of | 0.5 | 1.0 | 1.0 | 0.0 | 0.0 |
|---|---|---|---|---|---|---|---|
| | | functional group in | | | | | |
| | | polyfunctional | | | | | |
| | | crosslinking agent | | | | | |
| | | relative to 1 mol of | | | | | |
| | | keto group in polymer | | | | | |
| | Ion-exchanged water | | 87 | 87 | 87 | 87 | 87 |
| | Total charged amount | | 186.5 | 186.5 | 186.5 | 186.5 | 186.5 |
| | Solid content concentration [mass %] | | 53% | 53% | 53% | 53% | 53% |
| Evaluation | Cycle | Capacity retention | 92.3 | 91.6 | 88.1 | 89.8 | 91.0 |
| results | Characteristics | rate [%] | | | | | |
| | | Evaluation | A | B | C | C | B |

### «Evaluation Results»

As is apparent from the results of Example 1 to 15, the binder for the secondary battery electrode of the present invention was excellent in the toughness of the binder coating film after immersion in the electrolytic solution, and the composition for the secondary battery electrode mixture layer (electrode slurry) containing the binder for the secondary battery electrode of the present invention was excellent in the electrolytic solution resistance of the secondary battery electrode mixture layer and the cycle characteristics of the secondary battery.

Among them, focusing on the presence or absence of the crosslinked structure of the polymer, when the crosslinked polymer was used (Example 1), the toughness of the binder coating film after immersion in the electrolytic solution, the electrolytic solution resistance of the secondary battery electrode mixture layer, and the cycle characteristics of the secondary battery were all more excellent than when the non-crosslinked polymer was used (Example 12).

Further, focusing on the structural unit of the polymer, when the content of the structural unit derived from the keto group-containing ethylenically unsaturated monomer was small relative to all the structural units (Examples 1 and 5), the toughness of the binder coating film after immersion in the electrolytic solution and the electrolytic solution resistance of the secondary battery electrode mixture layer were both more excellent than when the content of the structural unit derived from the monomer was large (Examples 6 and 7).

Further, when DAAM was used as the structural unit derived from the keto group-containing ethylenically unsaturated monomer (Example 1), the electrolytic solution resistance of the secondary battery electrode mixture layer and the cycle characteristics of the secondary battery were more excellent than when AAEM was used as the monomer (Example 8).

Furthermore, focusing on a method for manufacturing the carboxyl group-containing polymer, when the keto group-containing ethylenically unsaturated monomer was added in the middle of polymerization and polymerized (Example 2), the toughness of the binder coating film after immersion in the electrolytic solution, the electrolytic solution resistance of the secondary battery electrode mixture layer, and the cycle characteristics of the secondary battery were more excellent than when the keto group-containing ethylenically unsaturated monomer was initially charged and polymerized (Example 1). This is presumed to be because the polar surface of the particle of R-1 that is the crosslinked polymer was surface-modified with the keto group-containing ethylenically unsaturated monomer, and as a result, the reaction between the keto group and the polyfunctional crosslinking agent was promoted.

In contrast, when a carboxyl group-containing polymer salt having a structural unit derived from an ethylenically unsaturated carboxylic acid monomer of less than 15 mass % was used, the toughness of the binder coating film, the electrolytic solution resistance, and the cycle characteristics were all significantly inferior (Comparative Example 1). Further, when the content of the structural unit derived from the carboxyl group-containing ethylenically unsaturated monomer was as small as 30 mass % (when the content of the structural unit derived from the keto group-containing ethylenically unsaturated monomer was as large as 70 mass %) (Example 7 and Comparative Example 2), the toughness of the binder coating film after immersion in the electrolytic solution, the electrolytic solution resistance of the secondary battery electrode mixture layer, and the cycle characteristics of the secondary battery were all significantly inferior when a carboxyl group-containing polymer salt containing no keto group-containing ethylenically unsaturated monomer was used (Comparative Example 2). Furthermore, when the composition for the secondary battery electrode mixture layer (electrode slurry) containing no polyfunctional crosslinking agent was used, the toughness of the binder coating film after immersion in the electrolytic solution was inferior (Comparative Example 3).

### INDUSTRIAL APPLICABILITY

The binder for the secondary battery electrode disclosed in the present specification is excellent in the toughness of the binder coating film after immersion in the electrolytic solution, and the secondary battery electrode mixture layer obtained using the electrode slurry containing the binder exhibits the electrolytic solution resistance.

Furthermore, the secondary battery including an electrode obtained using the binder can ensure good integrity and exhibits good durability (cycle characteristics) even when charging and discharging are repeated, and thus is expected to contribute to increasing capacity of the vehicle-mounted secondary battery and the like.

The binder for the secondary battery electrode of the present invention can be particularly suitably used for a nonaqueous electrolyte secondary battery electrode, and is particularly useful for a nonaqueous electrolyte lithium ion secondary battery having high energy density.

1. A binder for a secondary battery electrode, the binder comprising a carboxyl group-containing polymer or a salt thereof, wherein
the carboxyl group-containing polymer contains 15 mass % or more and 99.9 mass % or less of a structural unit derived from an ethylenically unsaturated carboxylic acid monomer and 0.1 mass % or more and 85 mass % or less of a structural unit derived from a keto group-containing ethylenically unsaturated monomer relative to all the structural units, and
at least a part of the keto group is a functional group used to form a chemical bond with a compound having reactivity with the keto group.

2. The binder for the secondary battery electrode according to claim 1, the binder further comprising a compound (hereinafter, referred to as a “polyfunctional crosslinking agent”) having two or more functional groups having reactivity with the keto group.

3. The binder for the secondary battery electrode according to claim 1, wherein the carboxyl group-containing polymer is a crosslinked polymer.

4. The binder for the secondary battery electrode according to claim 3, wherein the crosslinked polymer is a crosslinked polymer obtained by polymerizing a monomer composition containing a non-crosslinkable monomer and a crosslinkable monomer (however, different from the polyfunctional crosslinking agent).

5. The binder for the secondary battery electrode according to claim 4, wherein an amount of the crosslinkable monomer used is 0.1 parts by mass or more and 2.0 parts by mass or less relative to 100 parts by mass of a total amount of the non-crosslinkable monomer.

6. The binder for the secondary battery electrode according to claim 3, wherein the crosslinked polymer has a particle diameter of 0.1 μm or more and 10.0 μm or less in terms of volume-based median diameter after being neutralized to a degree of neutralization of 80 to 100 mol % and then measured in an aqueous medium.

7. The binder for the secondary battery electrode according to claim 2, wherein the polyfunctional crosslinking agent contains a polyfunctional crosslinking agent having a hydrazide group.

8. A composition for a secondary battery electrode mixture layer, the composition comprising the binder for the secondary battery electrode according to claim 2, an active material, and water.

9. The composition for the secondary battery electrode mixture layer according to claim 8, wherein the active material contains a silicon-based active material.

10. A secondary battery electrode comprising a mixture layer formed from the composition for the secondary battery electrode mixture layer according to claim 8 on a surface of a current collector.

11. A secondary battery comprising the secondary battery electrode according to claim 10.

12. A method for manufacturing a binder for a secondary battery electrode, the binder containing a carboxyl group-containing polymer or a salt thereof, wherein
the carboxyl group-containing polymer is obtained by a method including a step of polymerizing a monomer component containing an ethylenically unsaturated carboxylic acid monomer and a monomer component containing a keto group-containing ethylenically unsaturated monomer by precipitation polymerization or dispersion polymerization.

13. The manufacturing method according to claim 12, wherein
the precipitation polymerization or the dispersion polymerization includes:
a step of polymerizing the monomer component containing the ethylenically unsaturated carboxylic acid monomer; and
a step of adding and polymerizing the monomer component containing the keto group-containing ethylenically unsaturated monomer in the middle of the above step.

14. The manufacturing method according to claim 12, wherein the carboxyl group-containing polymer contains 15 mass % or more and 99.9 mass % or less of the ethylenically unsaturated carboxylic acid monomer and 0.1 mass % or more and 85 mass % or less of the keto group-containing ethylenically unsaturated monomer.
